(19) United States
(12) Patent Application Publication
(10) Pub. No.: US 2014/0050262 A1
(43) Pub. Date: Feb. 20, 2014

(54) IMAGE PROCESSING DEVICE AND IMAGE PROCESSING METHOD

(71) Applicants: Hironari Sakurai, Tokyo (JP); Junichi Tanaka, Kanagawa (JP)

(72) Inventors: Hironari Sakurai, Tokyo (JP); Junichi Tanaka, Kanagawa (JP)

(73) Assignee: SONY CORPORATION, Tokyo (JP)

(21) Appl. No.: 14/113,469

(22) PCT Filed: Apr. 3, 2012
(86) PCT No.: PCT/JP12/59061

§ 371 Date: Oct. 23, 2013

(30) Foreign Application Priority Data
May 9, 2011 (JP) 2011-104756

(51) Int. Cl. H04N 7/26

(52) U.S. Cl. CPC H04N 19/00096
USPC 375/240.03

(57) ABSTRACT

There is provided an image processing device including a setting section that sets, for respective transform units, a quantization matrix used when inversely quantizing transform coefficient data of an image to be decoded, according to an orthogonal transform method selected when inversely orthogonally transforming the transform coefficient data, an inverse quantization section that uses the quantization matrix set by the setting section to inversely quantize the transform coefficient data, and a transform section that uses the selected orthogonal transform method to inversely orthogonally transform the transform coefficient data inversely quantized by the inverse quantization section.

### TECHNICAL FIELD

The present disclosure relates to an image processing device and an image processing method.

### BACKGROUND ART

In H.264/AVC, one of the standard specifications for video encoding schemes, it is possible to use different quantization steps for each component of the orthogonal transform coefficients when quantizing image data in the High Profile or higher profile. A quantization step for each component of the orthogonal transform coefficients may be set on the basis of a quantization matrix (also called a scaling list) defined at the same size as the units of orthogonal transform, and a standard step value.

FIG. 28 illustrates four classes of default quantization matrices which are predefined in H.264/AVC. The matrix SL1 is the default 4×4 quantization matrix for intra prediction mode. The matrix SL2 is the default 4×4 quantization matrix for inter prediction mode. The matrix SL3 is the default 8×8 quantization matrix for intra prediction mode. The matrix SL4 is the default 8×8 quantization matrix for inter prediction mode. The user may also define one's own quantization matrix that differs from the default matrices illustrated in FIG. 28 in the sequence parameter set or the picture parameter set. Note that in the case where no quantization matrix is specified, a flat quantization matrix having an equal quantization step for all components may be used.

In High Efficiency Video Coding (HEVC), whose standardization is being advanced as a next-generation image encoding scheme to succeed H.264/AVC, there is introduced the concept of a coding unit (CU), which corresponds to a macroblock of the past (see Non-Patent Literature 1 below). Furthermore, one coding unit may be split into one or more units of orthogonal transform, or in other words, one or more transform units (TUs). Each transform unit is then subjected an orthogonal transform from image data into transform coefficient data, and the transform coefficient data is quantized.

Non-Patent Literature 2 below discusses how coding efficiency is improved in some cases by using a discrete sine transform (DST) instead of a discrete cosine transform (DCT) during orthogonal transform in a 4×4 intra prediction mode.

### CITATION LIST

### Non-Patent Literature

Non-Patent Literature 1: JCTVC-B205, “Test Model under Consideration”, Joint Collaborative Team on Video Coding (JCT-VC) of ITU-T SG16 WP3 and ISO/IEC JTC1/SC29/WG11 2nd Meeting: Geneva, CH, 21-28 Jul. 2010.
Non-Patent Literature 2: JCTVC-E125, “CE7: Mode-dependent DCT/DST without 4*4 full matrix multiplication for intra prediction”, ITU-T SG 16 WP3 and ISO/IEC JTC1/SC29/WG11 5th Meeting: Geneva, CH, 16-23 Mar. 2011.

### SUMMARY OF INVENTION

### Technical Problem

However, the tendency of the derived transform coefficient data differs depending on the orthogonal transform method used during the orthogonal transform on the image data. For example, it has been established that higher-range transform coefficients are more easily produced with a DST method compared to a DCT method. Consequently, in the case of using multiple orthogonal transform methods as proposed in Non-Patent Literature 2 above, from the perspective of preventing worsened image quality due to quantization, it is desirable to provide a mechanism enabling the adaptive switching of quantization matrices according to orthogonal transform method in use.

### Solution to Problem

According to an embodiment of the present disclosure, there is provided an image processing device including a setting section that sets, for respective transform units, a quantization matrix used when inversely quantizing transform coefficient data of an image to be decoded, according to an orthogonal transform method selected when inversely orthogonally transforming the transform coefficient data, an inverse quantization section that uses the quantization matrix set by the setting section to inversely quantize the transform coefficient data, and a transform section that uses the selected orthogonal transform method to inversely orthogonally transform the transform coefficient data inversely quantized by the inverse quantization section.

The image processing device may be typically realized as an image decoding device that decodes an image.

According to an embodiment of the present disclosure, there is provided an image processing method including setting, for respective transform units, a quantization matrix used when inversely quantizing transform coefficient data of an image to be decoded, according to an orthogonal transform method selected when inversely orthogonally transforming the transform coefficient data, inversely quantizing the transform coefficient data using the set quantization matrix, and inversely orthogonally transforming the inversely quantized transform coefficient data using the selected orthogonal transform method.

According to an embodiment of the present disclosure, there is provided an image processing device including a transform section that transforms image data into transform coefficient data using an orthogonal transform method selected for respective transform units of an image to be encoded, a setting section that sets a quantization matrix used when quantizing the transform coefficient data for respective transform units according to an orthogonal transform method used by the transform section, and a quantization section that uses the quantization matrix set by the setting section to quantize the transform coefficient data.

The image processing device may be typically realized as an image encoding device that encodes an image.

According to an embodiment of the present disclosure, there is provided an image processing method including transforming image data into transform coefficient data using an orthogonal transform method selected for respective transform units of an image to be encoded, setting a quantization matrix used when quantizing the transform coefficient data for respective transform units according to an orthogonal transform method used when transforming the image data, and quantizing the transform coefficient data using the set quantization matrix.

### Advantageous Effects of Invention

As described above, according to the present disclosure, it becomes possible to adaptively switch the quantization matrix according to the orthogonal transform method in use.

### BRIEF DESCRIPTION OF DRAWINGS

FIG. 1 is a block diagram illustrating an exemplary configuration of an image encoding device according to an embodiment.

FIG. 2 is a block diagram illustrating an example of a detailed configuration of the syntax processing section illustrated in FIG. 1.

FIG. 3 is a block diagram illustrating an example of a detailed configuration of the orthogonal transform section illustrated in FIG. 1.

FIG. 4 is an explanatory diagram illustrating base patterns of orthogonal transform methods which may be selected in an embodiment.

FIG. 5 is a block diagram illustrating an example of a detailed configuration of the quantization section illustrated in FIG. 1.

FIG. 6 is an explanatory diagram illustrating an example of parameters for generating a quantization matrix.

FIG. 7 is an explanatory diagram for explaining the generation of a DST quantization matrix in a gradient operation mode.

FIG. 8 is an explanatory diagram for explaining the generation of a DST quantization matrix in a coefficient table mode.

FIG. 9 is an explanatory diagram for explaining the generation of compound transform quantization matrices in a blend operation mode.

FIG. 10 is an explanatory diagram illustrating a first part of illustrative pseudo-code expressing parameter syntax.

FIG. 11 is an explanatory diagram illustrating a second part of illustrative pseudo-code expressing parameter syntax.

FIG. 12 is an explanatory diagram illustrating a third part of illustrative pseudo-code expressing parameter syntax.

FIG. 13 is an explanatory diagram illustrating a fourth part of illustrative pseudo-code expressing parameter syntax.

FIG. 14 is an explanatory diagram illustrating a fifth part of illustrative pseudo-code expressing parameter syntax.

FIG. 15 is a flowchart illustrating an example of the flow of a quantization process according to an embodiment.

FIG. 16 is a flowchart illustrating an example of the flow of a quantization process according to an exemplary modification.

FIG. 17 is a block diagram illustrating an exemplary configuration of an image decoding device according to an embodiment.

FIG. 18 is a block diagram illustrating an example of a detailed configuration of the syntax processing section illustrated in FIG. 17.

FIG. 19 is a block diagram illustrating an example of a detailed configuration of the inverse quantization section illustrated in FIG. 17.

FIG. 20 is a block diagram illustrating an example of a detailed configuration of the inverse orthogonal transform section illustrated in FIG. 17.

FIG. 21 is a flowchart illustrating an exemplary flow of a quantization matrix generation process according to an embodiment.

FIG. 22 is a flowchart illustrating an exemplary flow of the DST quantization matrix generation process illustrated in FIG. 21.

FIG. 23 is a flowchart illustrating an exemplary flow of the compound transform quantization matrix generation process illustrated in FIG. 21.

FIG. 24 is a block diagram illustrating an example of a schematic configuration of a television.

FIG. 25 is a block diagram illustrating an example of a schematic configuration of a mobile phone.

FIG. 26 is a block diagram illustrating an example of a schematic configuration of a recording and playback device.

FIG. 27 is a block diagram illustrating an example of a schematic configuration of an imaging device.

FIG. 28 is an explanatory diagram illustrating default quantization matrices which are predefined in H.264/AVC.

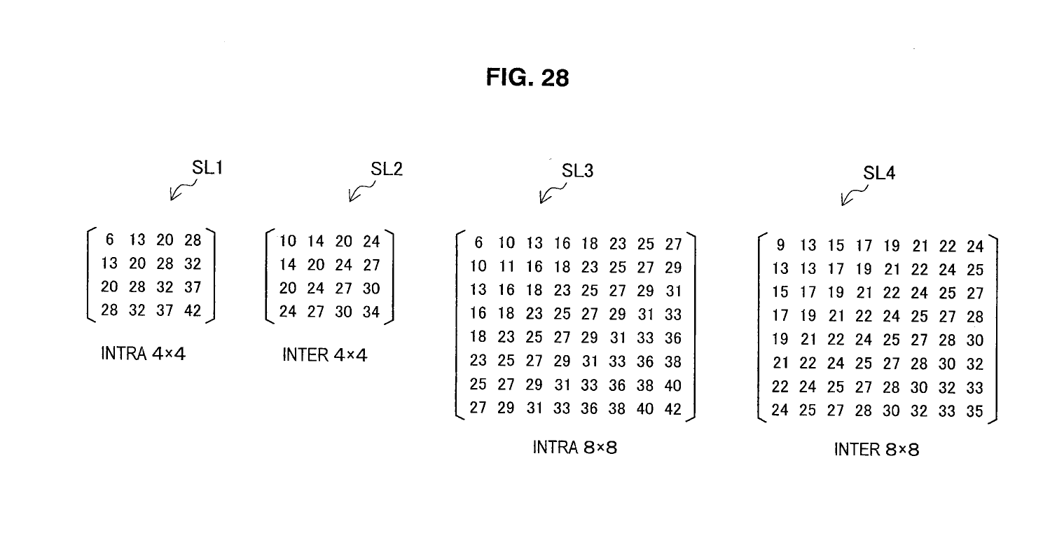

### DESCRIPTION OF EMBODIMENTS

Hereinafter, preferred embodiments of the present invention will be described in detail with reference to the appended drawings. Note that, in this specification and the drawings, elements that have substantially the same function and structure are denoted with the same reference signs, and repeated explanation is omitted.

Also, the description will proceed in the following order.
1. Exemplary Configuration of Image Encoding Device According to Embodiment
   1-1. Exemplary Overall Configuration
   1-2. Exemplary configuration of syntax processing section
   1-3. Exemplary configuration of orthogonal transform section
   1-4. Exemplary configuration of quantization section
   1-5. Exemplary parameter structure
   1-6. Generating a DST quantization matrix
   1-7. Generating compound transform quantization matrices
2. Syntax examples
3. Process flow during encoding according to embodiment
4. Exemplary configuration of image decoding device according to embodiment
   4-1. Exemplary overall configuration
   4-2. Exemplary configuration of syntax processing section
   4-3. Exemplary configuration of inverse quantization section
   4-4. Exemplary configuration of inverse orthogonal transform section
5. Process flow during decoding according to embodiment
6. Applications
7. Conclusion

### 1. EXEMPLARY CONFIGURATION OF IMAGE ENCODING DEVICE ACCORDING TO EMBODIMENT

This section describes an exemplary configuration of an image encoding device according to an embodiment.

[1-1. Exemplary Overall Configuration]

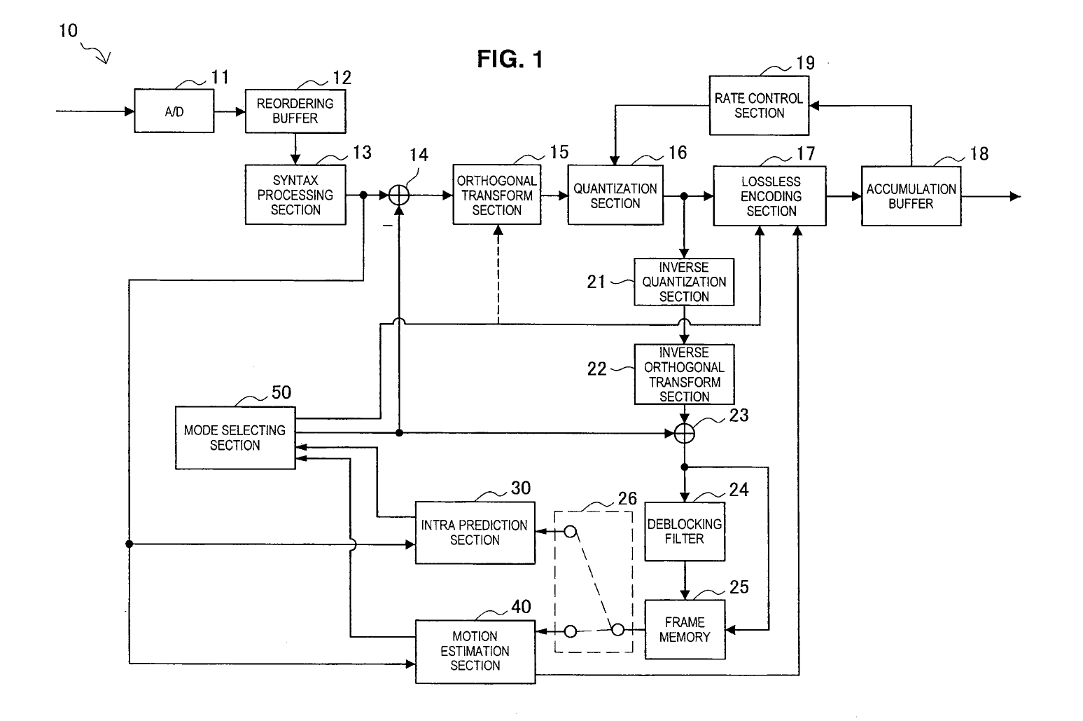

FIG. 1 is a block diagram illustrating an exemplary configuration of an image encoding device 10 according to an embodiment. Referring to FIG. 1, the image encoding device 10 is equipped with an analog-to-digital (A/D) conversion section 11, a reordering buffer 12, a syntax processing section 13, a subtraction section 14, an orthogonal transform section 15, a quantization section 16, a lossless encoding section 17, an accumulation buffer 18, a rate control section 19, an inverse quantization section 21, an inverse orthogonal transform section 22, an addition section 23, a deblocking filter 24, frame memory 25, a selector 26, an intra prediction section 30, a motion estimation section 40, and a mode selecting section 50.

The A/D conversion section 11 converts an image signal input in an analog format into image data in a digital format, and outputs a sequence of digital image data to the reordering buffer 12.

The reordering buffer 12 reorders the images included in the sequence of image data input from the A/D conversion section 11. After reordering the images according to a group of pictures (GOP) structure in accordance with the encoding process, the reordering buffer 12 outputs the reordered image data to the syntax processing section 13.

The image data output from the reordering buffer 12 to the syntax processing section 13 is mapped to a bitstream in units called Network Abstraction Layer (NAL) units. The stream of image data includes one or more sequences. The leading picture in a sequence is called the instantaneous decoding refresh (IDR) picture. Each sequence includes one or more pictures, and each picture further includes one or more slices. In H.264/AVC and HEVC, these slices are the basic units of video encoding and decoding. The data for each slice is recognized as a Video Coding Layer (VCL) NAL unit.

The syntax processing section 13 sequentially recognizes the NAL units in the stream of image data input from the reordering buffer 12, and inserts non-VCL NAL units storing header information into the stream. The non-VCL NAL units that the syntax processing section 13 inserts into the stream include sequence parameter sets (SPSs) and picture parameter sets (PPSs). Note that another new parameter set different from SPS and PPS may be set. For example, the syntax processing section 13 may insert into the stream a quantization matrix parameter set (QMPS), which stores only parameters related to the quantization matrix described later. The syntax processing section 13 also adds a slice header (SH) at the beginning of the slices. The syntax processing section 13 then outputs the stream of image data including VCL NAL units and non-VCL NAL units to the subtraction section 14, the intra prediction section 30, and the motion estimation section 40. A detailed configuration of the syntax processing section 13 will be further described later.

The subtraction section 14 is supplied with the image data input from the syntax processing section 13, and predicted image data selected by the mode selecting section 50 described later. The subtraction section 14 calculates prediction error data, which is the difference between the image data input from the syntax processing section 13 and the predicted image data input from the mode selecting section 50, and outputs the calculated prediction error data to the orthogonal transform section 15.

For each transform unit of an image to be encoded, the orthogonal transform section 15 transforms image data into transform coefficient data by using an orthogonal transform method selected from multiple orthogonal transform method candidates. The image data subjected to an orthogonal transform by the orthogonal transform section 15 is prediction error data input from the subtraction section 14. The multiple orthogonal transform method candidates may include methods such as a discrete cosine transform (DCT) method, a discrete sine transform (DST) method, a Hadamard transform method, a Karhunen-Loeve transform method, as well as combinations thereof, for example. Note that the description hereinafter in this specification assumes that the orthogonal transform section 15 is able to select from among a DCT method, a DST method, and combinations of these two methods (hereinafter designated compound transform methods). The orthogonal transform section 15 outputs transform coefficient data transformed from prediction error data via an orthogonal transform process to the quantization section 16. A detailed configuration of the orthogonal transform section 15 will be further described later.

The quantization section 16 uses a quantization matrix to quantize the transform coefficient data input from the orthogonal transform section 15, and outputs the quantized transform coefficient data (hereinafter referred to as quantized data) to the lossless encoding section 17 and the inverse quantization section 21. The bit rate of the quantized data is controlled on the basis of a rate control signal from the rate control section 19. The quantization matrix used by the quantization section 16 is defined in the SPS, PPS, or another parameter set, and may be specified in the slice header for each slice. In the case where a quantization matrix is not specified, a flat quantization matrix having an equal quantization step for all components is used. A detailed configuration of the quantization section 16 will be further described later.

The lossless encoding section 17 generates an encoded stream by performing a lossless encoding process on the quantized data input from the quantization section 16. The lossless encoding by the lossless encoding section 17 may be variable-length coding or arithmetic coding, for example. Furthermore, the lossless encoding section 17 multiplexes information about intra prediction or information about inter prediction input from the mode selecting section 50 into the header of the encoded stream. The lossless encoding section 17 then outputs the encoded stream thus generated to the accumulation buffer 18.

The accumulation buffer 18 uses a storage medium such as semiconductor memory to temporarily buffer the encoded stream input from the lossless encoding section 17. The accumulation buffer 18 then outputs the encoded stream thus buffered to a transmission section not illustrated (such as a communication interface or a connection interface with peripheral equipment, for example), at a rate according to the bandwidth of the transmission channel.

The rate control section 19 monitors the free space in the accumulation buffer 18. Then, the rate control section 19 generates a rate control signal according to the free space in the accumulation buffer 18, and outputs the generated rate control signal to the quantization section 16. For example, when there is not much free space in the accumulation buffer 18, the rate control section 19 generates a rate control signal for lowering the bit rate of the quantized data. Also, when there is sufficient free space in the accumulation buffer 18, for example, the rate control section 19 generates a rate control signal for raising the bit rate of the quantized data.

The inverse quantization section 21 performs an inverse quantization process on the quantized data input from the quantization section 16, using the same quantization matrix as the one set during the quantization process by the quantization section 16. The inverse quantization section 21 then outputs transform coefficient data acquired by the inverse quantization process to the inverse orthogonal transform section 22.

The inverse orthogonal transform unit 22 restores the prediction error data by applying an inverse orthogonal transform to the transform coefficient data input from the inverse quantization section 21. The orthogonal transform method used by the inverse orthogonal transform section 22 is equal to the method selected during the orthogonal transform process by the orthogonal transform section 15. The inverse orthogonal transform section 22 then outputs the restored prediction error data to the addition section 23.

The addition section 23 adds the restored prediction error data input from the inverse orthogonal transform section 22 and the predicted image data input from the mode selecting section 50 to thereby generate decoded image data. Then, the addition section 23 outputs the decoded image data thus generated to the deblocking filter 24 and the frame memory 25.

The deblocking filter 24 applies filtering to reduce blocking artifacts produced at the time of image encoding. The deblocking filter 24 removes blocking artifacts by filtering the decoded image data input from the addition section 23, and outputs the decoded image data thus filtered to the frame memory 25.

The frame memory 25 uses a storage medium to store the decoded image data input from the addition section 23 and the decoded image data after filtering input from the deblocking filter 24.

The selector 26 reads, from the frame memory 25, unfiltered decoded image data to be used for intra prediction, and supplies the decoded image data thus read to the intra prediction section 30 as reference image data. Also, the selector 26 reads, from the frame memory 25, the filtered decoded image data to be used for inter prediction, and supplies the decoded image data thus read to the motion estimation section 40 as reference image data.

The intra prediction section 30 performs an intra prediction process in each intra prediction mode, on the basis of the image data to be encoded that is input from the syntax processing section 13, and the decoded image data supplied via the selector 26. For example, the intra prediction section 30 evaluates the prediction result of each intra prediction mode using a predetermined cost function. Then, the intra prediction section 30 selects the intra prediction mode yielding the smallest cost function value, that is, the intra prediction mode yielding the highest compression ratio, as the optimal intra prediction mode. The intra prediction section 30 then outputs the predicted image data, information about intra prediction including the selected optimal intra prediction mode or the like, and the cost function value, to the mode selecting section 50. The information related to intra prediction may include information expressing optimal prediction directions for intra prediction.

The motion estimation section 40 performs an inter prediction process (prediction process between frames) on the basis of image data to be encoded that is input from the syntax processing section 13, and decoded image data supplied via the selector 26. For example, the motion estimation section 40 evaluates the prediction result of each prediction mode using a predetermined cost function. Then, the motion estimation section 40 selects the prediction mode yielding the smallest cost function value, that is, the prediction mode yielding the highest compression ratio, as the optimal prediction mode. The motion estimation section 40 generates predicted image data according to the optimal prediction mode. The motion estimation section 40 outputs the predicted image data, information about inter prediction including the selected optimal prediction mode or the like, and the cost function value, to the mode selecting section 50.

The mode selecting section 50 compares the cost function value related to intra prediction input from the intra prediction section 30 to the cost function value related to inter prediction input from the motion estimation section 40. Then, the mode selecting section 50 selects the prediction method with the smaller cost function value between intra prediction and inter prediction. In the case of selecting intra prediction, the mode selecting section 50 outputs the information about intra prediction to the orthogonal transform section 15 and the lossless encoding section 17, and also outputs the predicted image data to the subtraction section 14 and the addition section 23. Also, in the case of selecting inter prediction, the mode selecting section 50 outputs the information about inter prediction described above to the lossless encoding section 17, and also outputs the predicted image data to the subtraction section 14 and the addition section 23.

[1-2. Exemplary Configuration of Syntax Processing Section]

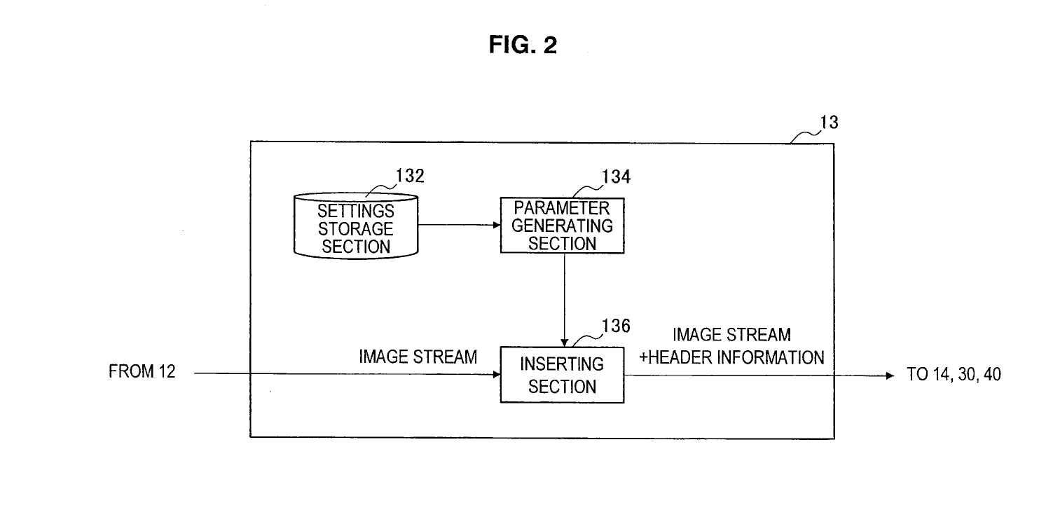

FIG. 2 is a block diagram illustrating an example of a detailed configuration of the syntax processing section 13 of the image encoding device 10 illustrated in FIG. 1. Referring to FIG. 2, the syntax processing section 13 includes a settings storage section 132, a parameter generating section 134, and an inserting section 136.

(1) Settings Storage Section

The settings storage section 132 stores various settings used for the encoding process by the image encoding device 10. For example, the settings storage section 132 stores information such as a profile for each sequence in the image data, the encoding mode for each picture, data regarding the GOP structure, as well as coding unit and transform unit settings. Also, in the present embodiment, the settings storage section 132 stores settings regarding quantization matrices used by the quantization section 16 (and the inverse quantization section 21). These settings may be predetermined for each slice, typically on the basis of offline image analysis.

(2) Parameter Generating Section

The parameter generating section 134 generates parameters defining settings stored by the settings storage section 132, and outputs the generated parameters to the inserting section 136.

For example, in the present embodiment, the parameter generating section 134 generates quantization matrix parameters for generating quantization matrices which may be used by the quantization section 16. The quantization matrices which may be used by the quantization section 16 include quantization matrices corresponding to each of the orthogonal transform method candidates which may be selected by the orthogonal transform section 15. An example of quantization matrix parameters generated by the parameter generating section 134 will be further described later.

(3) Inserting Section

The inserting section 136 inserts header information, such as SPSs, PPSs, and slice headers that respectively include parameter groups generated by the parameter generating section 134, into the stream of image data input from the reordering buffer 12. The header information inserted into the stream of image data by the inserting section 136 includes the quantization matrix parameters generated by the parameter generating section 134. The inserting section 136 then outputs the stream of image data with inserted header information to the subtraction section 14, the intra prediction section 30, and the motion estimation section 40.

[1-3. Exemplary Configuration of Orthogonal Transform Section]

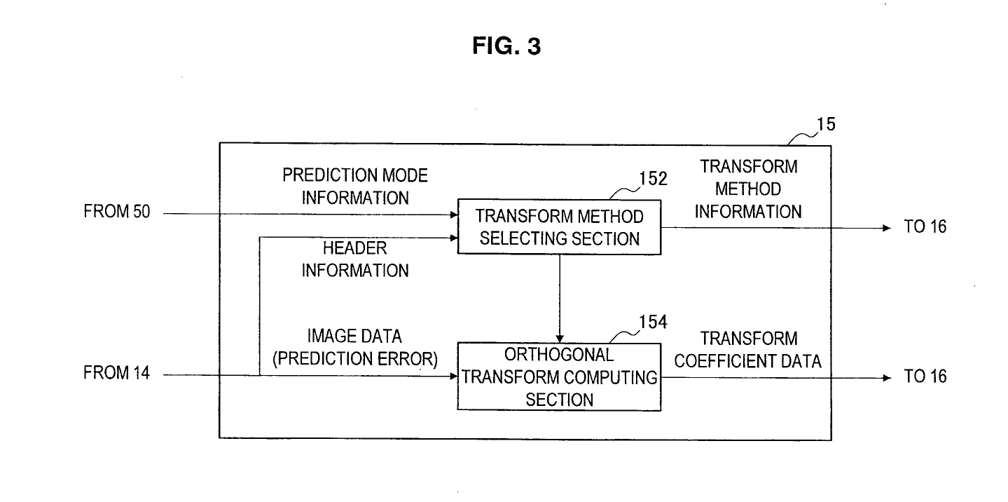

FIG. 3 is a block diagram illustrating an example of a detailed configuration of the orthogonal transform section 15 of the image encoding device 10 illustrated in FIG. 1. Referring to FIG. 3, the orthogonal transform section 15 includes a transform method selecting section 152 and an orthogonal transform computing section 154.

(1) Transform Method Selecting Section

The transform method selecting section 152 selects, from among the multiple orthogonal transform method candidates, an orthogonal transform method to use for the orthogonal transform of prediction error data for each transform unit. For example, in H.264/AVC, a DCT method is the orthogonal transform method used for the orthogonal transform of prediction error data. On the other hand, in the present embodiment, the transform method selecting section 152 applies the rationale proposed in the above Non-Patent Literature 2, and is able to select from among the following four orthogonal transform methods:
a) DCT method
b) DST method
c) Compound transform method (DST_DCT)
d) Compound transform method (DCT_DST)
   Of these, a) DCT method is the orthogonal transform method ordinarily used in H.264/AVC and the like, in which the DCT is applied in both the vertical direction and the horizontal direction. In b) DST method, the DST is applied in both the vertical direction and the horizontal direction. In c) DST_{_{—}}_{DCT} method, frequency components in the vertical direction and extracted by the DST, while frequency components in the horizontal direction are extracted by the DCT. In d) DCT_DST method, frequency components in the vertical direction and extracted by the DCT, while frequency components in the horizontal direction are extracted by the DST. In other words, in the present embodiment, the transform method selecting section 152 is able to select different orthogonal transform methods for the orthogonal transform in the vertical direction and the orthogonal transform in the horizontal direction.

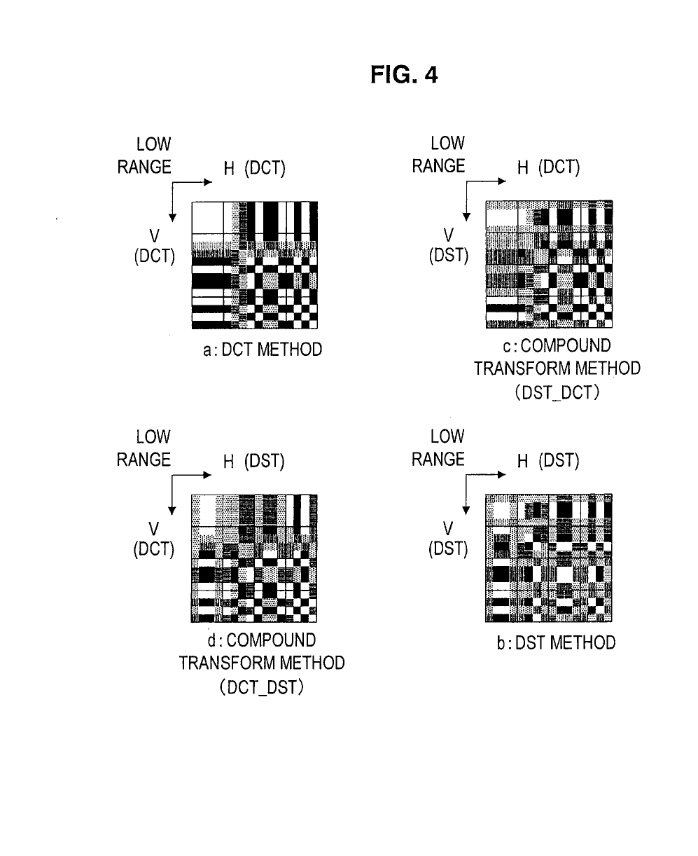

FIG. 4 is a diagram that conceptually illustrates the base patterns of the above-described four orthogonal transform methods that are selectable by the transform method selecting section 152. Referring to FIG. 4, respective examples of base patterns are illustrated for a) DCT method in the upper-left, b) DST method in the lower-right, c) DST_DCT method in the upper-right, and d) DCT_DST method in the lower-left. Bands in each base pattern are indicated as changes in shading, with the band changing from low-range to high-range proceeding from the upper-left to the lower-right of each pattern. One point that FIG. 4 demonstrates is that in the three methods other than the DCT method, the element in the upper-left corner is not an entirely direct-current (DC) component. Consequently, in the case of applying the DST in at least one of the vertical direction and the horizontal direction, transform coefficients significant to the high-frequency component may more readily appear in the direction in which the DST is applied, compared to the case of applying the DCT in both direction. Also, by applying the DST in either direction, the tendency of the transform coefficient data derived by the orthogonal transform differs depending on the direction in which the DST is applied.

The selection of an orthogonal transform method by the transform method selecting section 152 may be conducted according to the technique described in the above Non-Patent Literature 2. In this case, the transform method selecting section 152 selects an orthogonal transform method for each direction on the basis of the prediction technique (intra prediction/inter prediction) selected by the mode selecting section 50, the size of the prediction units, and the prediction direction. For example, the transform method selecting section 152 selects the DCT method in the case of inter prediction, or in the case of 8×8 or larger intra prediction. On the other hand, in the case of 4×4 intra prediction, the transform method selecting section 152 switches the orthogonal transform method according to the prediction direction of the intra prediction. The mapping between prediction directions of intra prediction and orthogonal transform methods to select may be the mapping as described in Table 1 of the above Non-Patent Literature 2. Another mapping may also be used. The transform method selecting section 152 then reports the selected orthogonal transform method for each transform unit to the orthogonal transform computing section 154.

(2) Orthogonal Transform Computing Section

The orthogonal transform computing section 154 uses the orthogonal transform method selected by the transform method selecting section 152 to transform prediction error data input from the subtraction section 14 into transform coefficient data for each transform unit. The orthogonal transform computing section 154 then outputs the transformed transform coefficient data to the quantization section 16. The transform method selecting section 152 also outputs transform method information expressing the orthogonal transform method selected for each transform unit to the quantization section 16.

[1-4. Exemplary Configuration of Quantization Section]

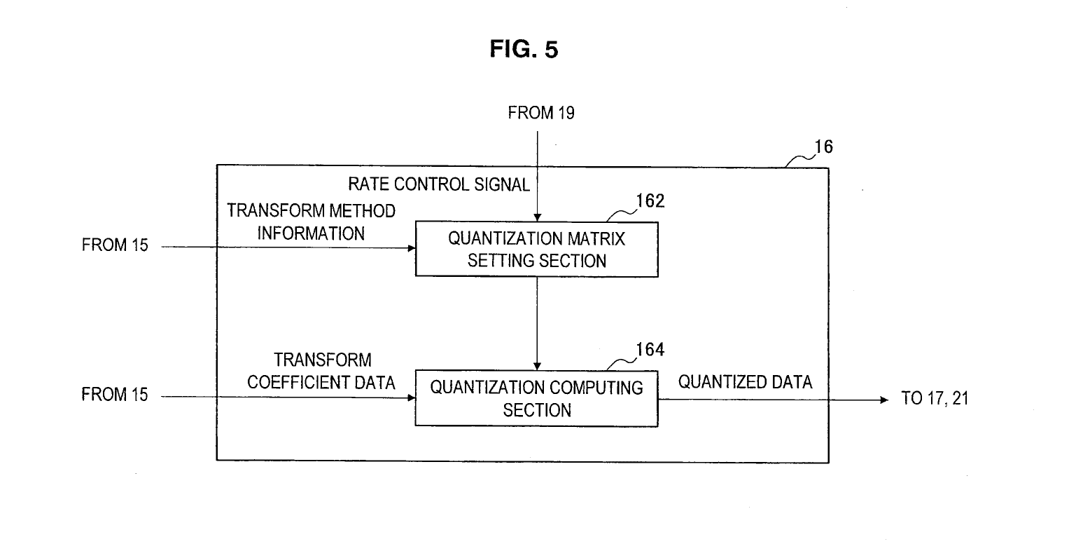

FIG. 5 is a block diagram illustrating an example of a detailed configuration of the quantization section 16 of the image encoding device 10 illustrated in FIG. 1. Referring to FIG. 5, the quantization section 16 includes a quantization matrix setting section 162 and a quantization computing section 164.

(1) Quantization Matrix Setting Section

The quantization matrix setting section 162 sets a quantization matrix for quantizing transform coefficient data for each transform unit according to the orthogonal transform method used by the orthogonal transform section 15. For example, the quantization matrix setting section 162 first acquires transform method information from the orthogonal transform section 15. The transform method information may be identification information that identifies the orthogonal transform method selected for each transform unit. Otherwise, the transform method information may be information expressing the prediction technique (intra prediction/inter prediction), the size of the prediction units, and the prediction direction corresponding to each transform unit.

The quantization matrix setting section 162 recognizes the orthogonal transform method used for each transform unit from the acquired transform method information, and sets a quantization matrix corresponding to the recognized orthogonal transform method for each transform unit. The quantization matrix setting section 162 may also uniformly set a DCT quantization matrix for the transform units in the case of inter prediction, or in the case of 8×8 or larger intra prediction, for example. The quantization step of the set quantization matrix may also be adjusted according to a rate control signal from the rate control section 19. Meanwhile, in the case of 4×4 intra prediction, the quantization matrix setting section 162 may acquire a quantization matrix corresponding to the recognized orthogonal transform method according to the mapping indicated in the following Table 1.

TABLE 1
Setting a quantization matrix according to transform method in use

| | | |
|---|---|---|
| Prediction | Transform method | Quantization |

| # | direction | Vertical | Horizontal | matrix |
|---|---|---|---|---|
| 0 | VER | DST | DCT | M_{DST}_{_{—}}_{DCT} |
| 1 | HOR | DCT | DST | M_{DCT}_{_{—}}_{DST} |
| 2 | DC | DCT | DCT | M_{DCT} |
| 3 | VER-8 | DST | DST | M_{DST} |
| 4 | VER-4 | DST | DST | M_{DST} |
| 5 | VER+4 | DST | DCT | M_{DST}_{_{—}}_{DCT} |
| 6 | VER+8 | DST | DCT | M_{DST}_{_{—}}_{DCT} |
| 7 | HOR-4 | DST | DST | M_{DST} |
| 8 | HOR+4 | DCT | DST | M_{DCT}_{_{—}}_{DST} |
| 9 | HOR+8 | DCT | DST | M_{DCT}_{_{—}}_{DST} |
| 10 | VER-6 | DST | DST | M_{DST} |
| 11 | VER-2 | DST | DST | M_{DST} |
| 12 | VER+2 | DST | DCT | M_{DST}_{_{—}}_{DCT} |
| 13 | VER+6 | DST | DCT | M_{DST}_{_{—}}_{DCT} |
| 14 | HOR-6 | DST | DST | M_{DST} |
| 15 | HOR-2 | DST | DST | M_{DST} |
| 16 | HOR+2 | DCT | DST | M_{DCT}_{_{—}}_{DST} |
| 17 | HOR+6 | DCT | DST | M_{DCT}_{_{—}}_{DST} |
| 18 | VER-7 | DST | DST | M_{DST} |
| 19 | VER-5 | DST | DST | M_{DST} |
| 20 | VER-3 | DST | DST | M_{DST} |
| 21 | VER-1 | DST | DST | M_{DST} |
| 22 | VER+1 | DST | DCT | M_{DST}_{_{—}}_{DCT} |
| 23 | VER+3 | DST | DCT | M_{DST}_{_{—}}_{DCT} |
| 24 | VER+5 | DST | DCT | M_{DST}_{_{—}}_{DCT} |
| 25 | VER+7 | DST | DCT | M_{DST}_{_{—}}_{DCT} |
| 26 | HOR-7 | DST | DST | M_{DST} |
| 27 | HOR-5 | DST | DST | M_{DST} |
| 28 | HOR-3 | DST | DST | M_{DST} |
| 29 | HOR-1 | DST | DST | M_{DST} |
| 30 | HOR+1 | DCT | DST | M_{DCT}_{_{—}}_{DST} |
| 31 | HOR+3 | DCT | DST | M_{DST}_{_{—}}_{DST} |
| 32 | HOR+5 | DCT | DST | M_{DCT}_{_{—}}_{DST} |
| 33 | HOR+7 | DCT | DST | M_{DCT}_{_{—}}_{DST} |

In Table 1, M_{DCT} is a DCT quantization matrix, M_{AST} is a DST quantization matrix, M_{DST}_{_{—}}_{DCT} is a DST_DCT quantization matrix, and M_{DCT}_{_{—}}_{DST} is a DCT_DST quantization matrix. The DST quantization matrix M_{DST} may be applied to yield a smooth quantization step gradient from low range to high range compared to the DCT quantization matrix M_{DCT}. Thus, the significance of the transform coefficients for the high-frequency component of the transform coefficient data derived via the DST is less easily lost. For example, the DCT quantization matrix M_{DCT} and the DST quantization matrix M_{DST} may be matrices like the following:

$${M}_{DCT} = [ \begin{matrix}6 & 12 & 24 & 36 \\ 12 & 24 & 36 & 48 \\ 24 & 36 & 48 & 60 \\ 36 & 48 & 60 & 72\end{matrix} ] , {M}_{DST} = [ \begin{matrix}10 & 10 & 10 & 20 \\ 10 & 10 & 20 & 20 \\ 10 & 20 & 20 & 30 \\ 20 & 20 & 30 & 30\end{matrix} ]$$

Also, the DST_DCT quantization matrix M_{DST}_{_{—}}_{DCT} and the DCT_DST quantization matrix M_{DCT}_{_{—}}_{DST} may be matrices like the following:

$${M}_{DST\_DCT} = [ \begin{matrix}6 & 12 & 24 & 36 \\ 17 & 19 & 27 & 38 \\ 19 & 27 & 38 & 50 \\ 27 & 38 & 50 & 58\end{matrix} ] , {M}_{DCT\_DST} = [ \begin{matrix}6 & 17 & 19 & 27 \\ 12 & 19 & 27 & 28 \\ 24 & 27 & 38 & 50 \\ 36 & 38 & 50 & 58\end{matrix} ]$$

With the above example, in the DST_DCT quantization matrix M_{DST}_{_{—}}_{DCT}, the quantization step gradient in the vertical direction is smoother than the quantization step gradient in the horizontal direction. Also, in the DCT_DST quantization matrix M_{DCT}_{_{—}}_{DST}, the quantization step gradient in the horizontal direction is smoother than the quantization step gradient in the vertical direction.

(2) Quantization Computing Section

The quantization computing section 164 uses the quantization matrix set by the quantization matrix setting section 162 to quantize the transform coefficient data input from the orthogonal transform section 15 for each transform unit. The quantization computing section 164 then outputs post-quantization transform coefficient data (quantized data) to the lossless encoding section 17 and the inverse quantization section 21. Note that the quantization matrices set by the quantization matrix setting section 162 may also be used during the inverse quantization at the inverse quantization section 21.

[1-5. Exemplary Parameter Structure]

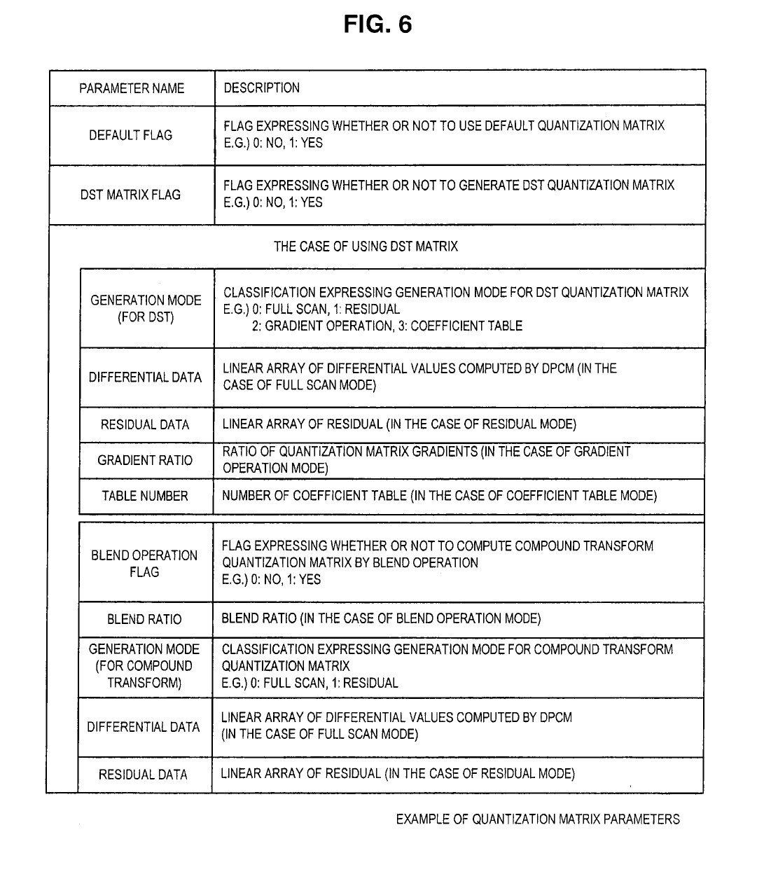

FIG. 6 illustrates an example of parameters related to quantization matrices other than the DCT quantization matrix, from among the quantization matrix parameters generated by the parameter generating section 134 of the syntax processing section 13. Note that the parameters related to the DCT quantization matrix may be parameters similar to those of an existing video coding scheme such as H.264/AVC.

Referring to FIG. 6, the quantization matrix parameters include a “default flag”, a “DST matrix flag”, and parameter groups for generating each quantization matrix.

The “default flag” is a flag expressing whether or not to use a default quantization matrix. In the case where the default flag indicates “0: No”, a unique quantization matrix different from the default quantization matrix is defined, and that unique quantization matrix is used during quantization. On the other hand, in the case where the default flag indicates “1: Yes”, the default quantization matrix is used during quantization.

The “DST matrix flag” is a flag expressing whether or not to generate a DST quantization matrix. In the case where the DST matrix flag indicates “0: No”, the DCT quantization matrix is used, even on transform units for which an orthogonal transform method other than the DCT method has been selected. On the other hand, in the case where the DST matrix flag indicates “1: Yes”, the DST quantization matrix (as well as the quantization matrices for the compound transforms) may be used, and these quantization matrices will be generated on the decoding side.

The “generation mode” is one parameter for generating a DST quantization matrix. The “generation mode” is a classification expressing how to generate the DST quantization matrix. As an example, the generation mode classification may take one of the following values:
0: Full scan mode
1: Residual mode
2: Gradient operation mode
3: Coefficient table mode

If the DST generation mode is “0: Full scan mode”, the quantization matrix parameters additionally include “differential data” for the DST. The “differential data” may be data obtained by converting all elements of the DST quantization matrix into a linear array using a zigzag scan, and encoding that linear array in differential pulse-code modulation (DPCM) format.

If the DST generation mode is “1: Residual mode”, the quantization matrix parameters additionally include “residual data” for the DST. The “residual data” may be data obtained by converting the differences for all elements between the DST quantization matrix and the DCT quantization matrix into a linear array using a zigzag scan.

If the DST generation mode is “2: Gradient operation mode”, the quantization matrix parameters additionally include a “gradient ratio”. The “gradient ratio” is data specifying the ratio between the gradient from low range to high range in the DCT quantization matrix, and the gradient from low range to high range in the DST quantization matrix. A process for generating a DST quantization matrix in gradient operation mode will be further described later.

If the DST generation mode is “3: Coefficient table mode”, the quantization matrix parameters additionally include a “table number”. The “table number” is data specifying the number of a table storing coefficients by which to multiply each element in the DCT quantization matrix in order to generate the DST quantization matrix. A process for generating a DST quantization matrix in coefficient table mode will be further described later.

The “blend operation flag” is a parameter for generating a quantization matrix for a compound transform. The “blend operation flag” is a flag expressing whether or not to compute a quantization matrix for a compound transform using a blend operation (or a weighted average) based on the DCT quantization matrix and the DST quantization matrix. In the case where the blend operation flag indicates “0: No”, a quantization matrix for a compound transform is generated in full scan mode or residual mode. On the other hand, in the case where the blend operation flag indicates “1: Yes”, a quantization matrix for a compound transform is computed with a blend operation.

If the blend operation flag is “1: Yes”, the quantization matrix parameters additionally include a “blend ratio”. The “blend ratio” is data specifying a ratio (or weighting) for each element in the case of blending the DST quantization matrix with the DCT quantization matrix. A process for generating a compound transform quantization matrix in blend operation mode will be further described later.

If the blend operation flag is “0: No”, the quantization matrix parameters additionally include a compound transform “generation mode”. The “generation mode” is a classification expressing how to generate a quantization matrix for a compound transform. As an example, the generation mode classification may take one of the following values:
0: Full scan mode
1: Residual mode

If the compound transform generation mode is “0: Full scan mode”, the quantization matrix parameters additionally include “differential data” for each of DST_DCT and DCT_DST. The “differential data” may be data obtained by converting all elements of each quantization matrix into a linear array using a zigzag scan, and encoding that linear array in DPCM format.

If the compound transform generation mode is “1: Residual mode”, the quantization matrix parameters additionally include “residual data” for each of DST_DCT and DCT_DST. The “residual data” may be data obtained by converting the differences for all elements between each quantization matrix and the DCT quantization matrix into a linear array using a zigzag scan.

As discussed earlier, the quantization matrix parameters exemplified in FIG. 6 may be inserted into the SPS or PPS, or a new parameter set different from these parameter sets. Note that these quantization matrix parameters are merely one example. In other words, some of the parameters among the above quantization matrix parameters may also be omitted, while other parameters may also be added.

[1-6. Generating a DST Quantization Matrix]

As described with respect to FIG. 6, the present embodiment supports several modes for generating a DST quantization matrix from a DCT quantization matrix. These modes are modes for raising coding efficiency over the case of transmitting the DST quantization matrix in full scan mode, and the mode that optimizes the coding efficiency may be selected from among multiple mode candidates. The modes for generating a DST quantization matrix from a DCT quantization matrix may include a residual mode, a gradient operation mode, and a coefficient table mode.

(1) Residual Mode

In residual mode, residual data expressing a linear array of the differences for all elements between the DST quantization matrix and the DCT quantization matrix may be transmitted from the encoding side to the decoding side. Then, on the decoding side, the residual error for each element included in the residual data is added to the value of each element in the DCT quantization matrix, and a DST quantization matrix is generated.

(2) Gradient Operation Mode

Gradient operation mode is a mode for generating a DST quantization matrix by transforming a DCT quantization matrix such that the gradient of element values from low range to high range becomes smoother. In gradient operation mode, a gradient ratio expressing the rate of change in the gradient of element values may be transmitted from the encoding side to the decoding side.

For example, a gradient ratio grad may be used to compute the element value M_{DST}(i, j) on the ith row and jth column of the DST quantization matrix according to the following formula:

M_{DST}(i,j)=M_{DCT}(0,0)+grad·(M_{DCT}(i,j)−M_{DCT}(0,0)) (1)

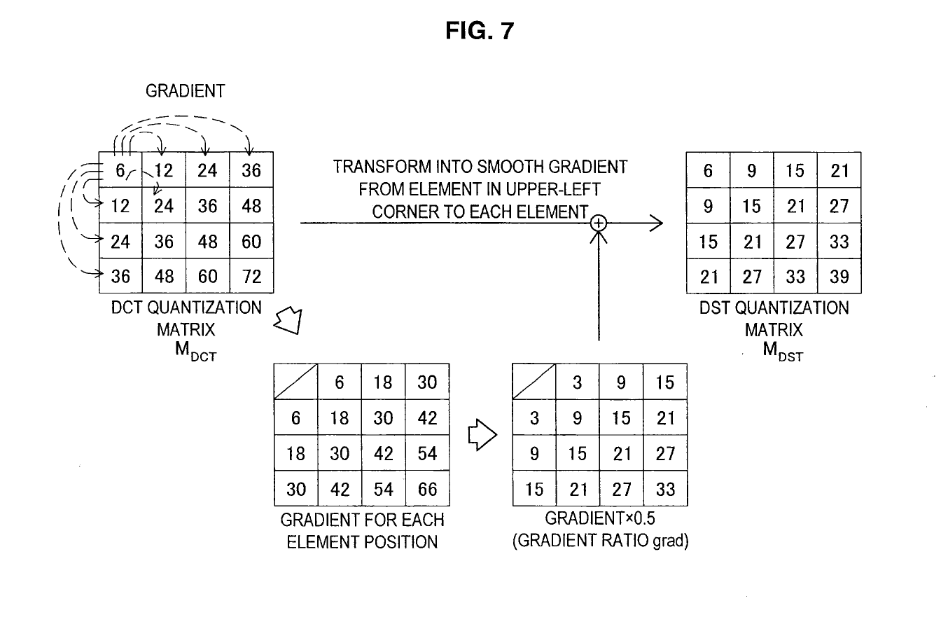

FIG. 7 is an explanatory diagram for explaining the generation of a DST quantization matrix in gradient operation mode. The left side of FIG. 7 illustrates a DCT quantization matrix M_{DCT} as an example. A gradient for each element position is derived as the difference between the element value at that element position and the element value at the upper-left corner (0th row, 0th column). In the example in FIG. 7, the gradient ratio is grad=0.5. The DST quantization matrix M_{DST} is computed by adding, to each element in the DCT quantization matrix M_{DCT}, the value obtained by multiplying the gradient corresponding to that element by the gradient ratio.

According to the gradient operation mode described above, it is possible to generate quantization matrices suited to different orthogonal transform methods from a single quantization matrix, simply by transmitting a gradient ratio only from the encoding side to the decoding side. Consequently, it becomes possible to generate multiple quantization matrix candidates and adaptively switch the quantization matrix without greatly lowering the coding efficiency. Also, according to the above formula using a gradient ratio, it is possible to easily generate a DST quantization matrix with a smooth gradient from low range to high range by simply specifying the gradient ratio only.

(3) Coefficient Table Mode

Similarly to gradient operation mode, coefficient table mode is a mode for generating a DST quantization matrix by transforming a DCT quantization matrix such that the gradient of element values from low range to high range becomes smoother. In coefficient table mode, multiple coefficient table candidates that respectively store coefficients by which to multiply the elements of a DCT quantization matrix are defined in advance and stored on both the encoding side and the decoding side. Then, a table number specifying a coefficient table to use may be transmitted from the encoding side to the decoding side. Note that the transmission of a table number may also be omitted in the case where only one coefficient table is defined.

For example, the element Tₜ₋ₙᵤₘ(i, j) on the ith row and jth column of a table specified by a table number t-num may be used to compute the element value M_{DST}(i, j) on the ith row and jth column of the DST quantization matrix according to the following formula:

M_{DST}(i,j)=Tₜ₋ₙᵤₘ(i,j)·M_{DCT}(i,j)) (2)

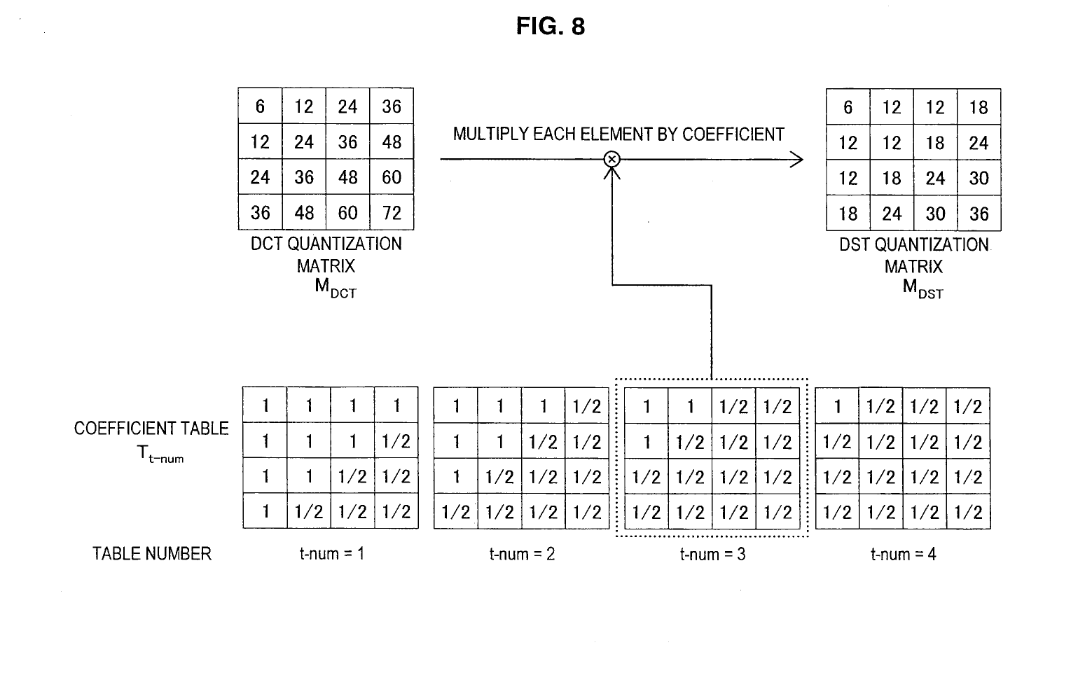

FIG. 8 is an explanatory diagram for explaining the generation of a DST quantization matrix in coefficient table mode. The left side of FIG. 8 illustrates a DCT quantization matrix M_{DCT} as an example. Also, the bottom of FIG. 8 illustrates four predefined coefficient tables Tₜ₋ₙᵤₘ (table numbers t-num=1, 2, 3, 4). Each coefficient in these coefficient tables is a positive number less than or equal to 1, and defined such that the values high-frequency coefficients are smaller than low-frequency coefficients. In the example in FIG. 8, the table number t-num=3 is specified. Consequently, a DST quantization matrix M_{DST} is computed by multiplying each element in the DCT quantization matrix M_{DCT} by each coefficient in the coefficient table T₃.

According to the coefficient table mode described above, it is possible to generate quantization matrices suited to different orthogonal transform methods from a single quantization matrix, simply by transmitting a table number only from the encoding side to the decoding side. Consequently, it becomes possible to generate multiple quantization matrix candidates and adaptively switch the quantization matrix without greatly lowering the coding efficiency. Additionally, since an optimal coefficient may be selected from among multiple coefficient table modes, it is possible to effectively mitigate worsened image quality due to quantization by selecting a coefficient table that is particularly suited to the properties of the orthogonal transform method being used or the tendency of the transform coefficient data.

[1-7. Generating Compound Transform Quantization Matrices]

The present embodiment supports several modes for generating compound transform quantization matrices from one or both of a DCT quantization matrix and a DST quantization matrix. These modes are modes for raising coding efficiency over the case of transmitting the compound transform quantization matrices in full scan mode, and the mode that optimizes the coding efficiency may be selected from among multiple mode candidates. The modes for generating compound transform quantization matrices may include a full scan mode, as well as a residual mode and a blend operation mode. Note that different generation modes may also be specified for the DST_DCT quantization matrix and the DCT_DST quantization matrix, respectively.

(1) Residual Mode

In residual mode, residual data expressing a linear array of the differences for all elements between a compound transform quantization matrix and the DCT (or DST) quantization matrix may be transmitted from the encoding side to the decoding side. Then, on the decoding side, the residual error for each element included in the residual data is added to the value of each element in the DCT (or DST) quantization matrix, and respective compound transform quantization matrices are generated.

(2) Blend Operation Mode

Blend operation mode is a mode for generating a compound transform quantization matrix by blending (computing a weighted average of) the DCT quantization matrix and the DST quantization matrix. In blend operation mode, data specifying a blend ratio (weighting) for each element position for the purpose of a blend operation may be transmitted from the encoding side to the decoding side. Note that the transmission of blend ratios may also be omitted by statically defining blend ratios between the encoding side and the decoding side in advance.

For example, a blend ratio Sv(i, j):Ch(i, j) of the vertical direction versus the horizontal direction may be used to compute the element value M_{DST}_{_{—}}_{DCT}(i, j) on the ith row and jth column of the DST_DCT quantization matrix according to the following formula:

$${M}_{DST\_DCT} ( i , j ) = \frac{{Ch}_{i , j} \cdot {M}_{DCT} ( i , j ) + {Sv}_{i , j} \cdot {M}_{DST} ( i , j )}{{Ch}_{i , j} + S {v}_{i , j}} \qquad ( 3 )$$

Similarly, a blend ratio Cv(i, j):Sh(i, j) of the vertical direction versus the horizontal direction may be used to compute the element value M_{DCT}_{_{—}}_{DST}(i, j) on the ith row and jth column of the DCT_DST quantization matrix according to the following formula:

$${M}_{DCT\_DST} ( i , j ) = \frac{{Cv}_{i , j} \cdot {M}_{DCT} ( i , j ) + {Sh}_{i , j} \cdot {M}_{DST} ( i , j )}{{Cv}_{i , j} + {Sh}_{i , j}} \qquad ( 4 )$$

Herein, the values Ch, Sv, Cv, and Sh constituting the blend ratios may be values like the following, for example. Note that Ch and Cv correspond to the weights by which the DCT quantization matrix is multiplied, whereas Sv and Sh correspond to the weights by which the DST quantization matrix is multiplied.

$${Ch}_{i , j} = [ \begin{matrix}3 & 3 & 3 & 3 \\ 2 & 2 & 2 & 2 \\ 2 & 2 & 2 & 2 \\ 1 & 1 & 1 & 1\end{matrix} ] , {Sv}_{i , j} = [ \begin{matrix}0 & 0 & 0 & 0 \\ 1 & 1 & 1 & 1 \\ 1 & 1 & 1 & 1 \\ 2 & 2 & 2 & 2\end{matrix} ]$$

$$C {v}_{i , j} = [ \begin{matrix}3 & 2 & 2 & 1 \\ 3 & 2 & 2 & 1 \\ 3 & 2 & 2 & 1 \\ 3 & 2 & 2 & 1\end{matrix} ] , {Sh}_{i , j} = [ \begin{matrix}0 & 1 & 1 & 2 \\ 0 & 1 & 1 & 2 \\ 0 & 1 & 1 & 2 \\ 0 & 1 & 1 & 2\end{matrix} ]$$

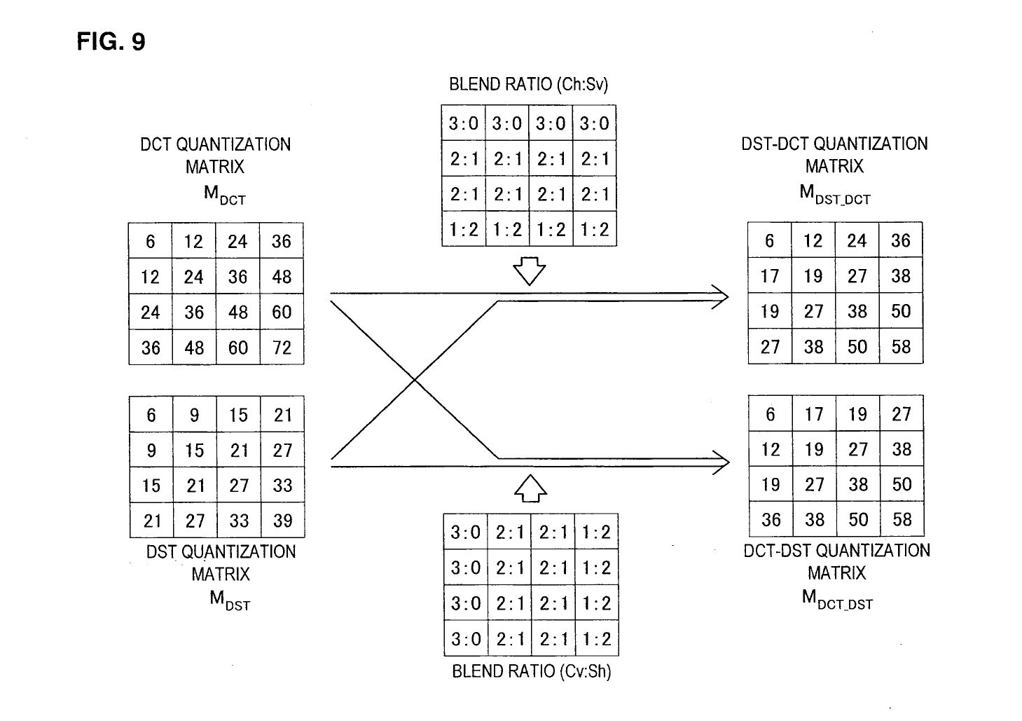

FIG. 9 is an explanatory diagram for explaining the generation of compound transform quantization matrices in blend operation mode. The left side of FIG. 9 illustrates a DCT quantization matrix M_{DCT} and a DST quantization matrix M_{DST} as an example. Also, the top of FIG. 9 illustrates a matrix of blend ratios Ch:Sv for generating a DST_DCT quantization matrix M_{DST}_{_{—}}_{DCT}. A DST_DCT quantization matrix M_{DST}_{_{—}}_{DCT} may be computed by using such blend ratios Ch:Sv to calculate a weighted average of the two quantization matrices M_{DCT} and M_{DST}. The bottom of FIG. 9 illustrates a matrix of blend ratios Cv:Sh for generating a DCT_DST quantization matrix M_{DCT}_{_{—}}_{DST}. A DCT_DST quantization matrix M_{DCT}_{_{—}}_{DST} may be computed by using such blend ratios Cv:Sh to calculate a weighted average of the two quantization matrices M_{DCT} and M_{DST}. As a result, two quantization matrices M_{DST}_{_{—}}_{DCT} and M_{DCT}_{_{—}}_{DST} are generated, in which the gradient along the direction in which the DST is used is smoother than the gradient along the direction in which the DCT is used.

According to the blend operation mode described above, it is possible to generate compound transform quantization matrices from non-compound transform quantization matrices, without transmitting definitions of the compound transform quantization matrices. Consequently, it becomes possible to suitably generate various quantization matrix candidates corresponding to respective combinations of orthogonal transform methods without greatly lowering the coding efficiency, even in cases where an orthogonal transform method whose orthogonal transform in the vertical direction differs from the orthogonal transform in the horizontal direction may be selected.

### 2. SYNTAX EXAMPLES

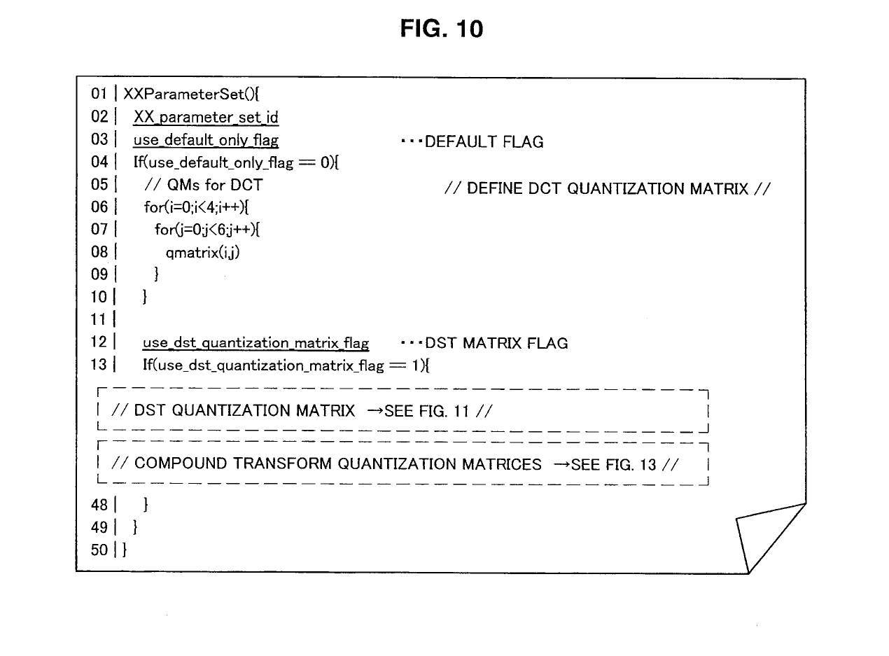

FIGS. 10 to 14 illustrate representative pseudo-code expressing the syntax of quantization matrix parameters according to the present embodiment. Line numbers are given on the left edge of the pseudo-code. Also, an underlined variable in the pseudo-code means that the parameter corresponding to that variable may be specified inside a parameter set. Note that for the sake of simplicity in the explanation, description of parameters other than the parameters relating to quantization matrices will be omitted.

The function XXParameterSet( ) on line 1 in FIG. 10 is a function that expresses the syntax of a single parameter set. On line 2, an ID for that parameter set (XX_parameter_set_id) is specified. By specifying the ID of the parameter set in each slice header, it becomes possible to identify the quantization matrix to use in that slice. On line 3, the default flag (use_default_only_flag) is specified. If the default flag is zero, parameters for quantization matrices (not the default) corresponding to each orthogonal transform method are specified on line 5 and thereafter.

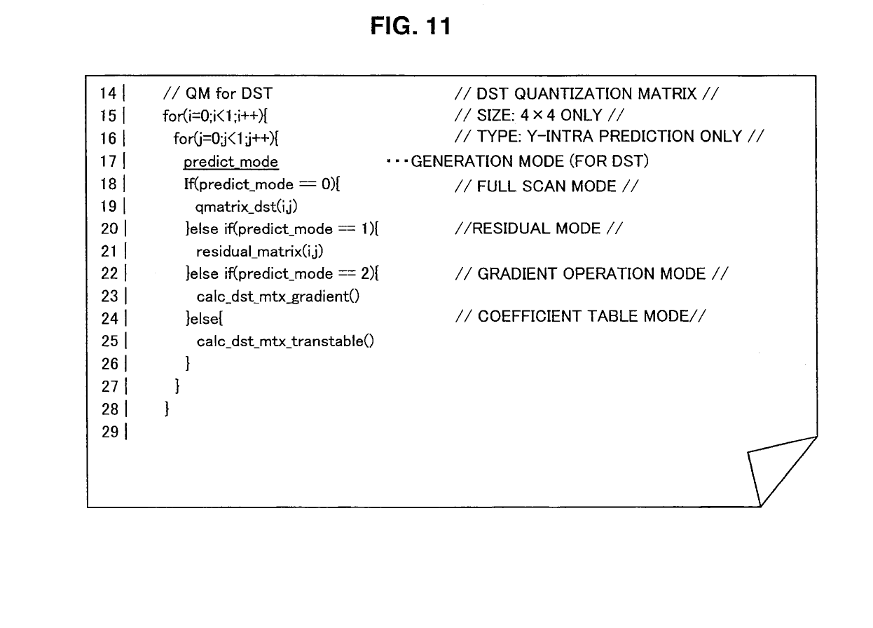

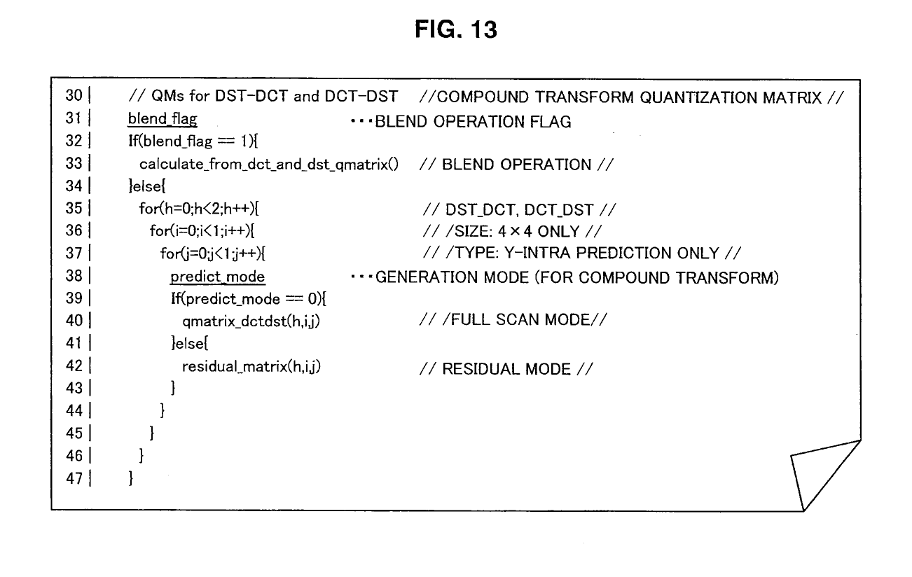

The syntax from line 6 to line 10 is the syntax for the DCT quantization matrix. The syntax for the DCT quantization matrix may be similar syntax to an existing video coding scheme. On line 12, the DST matrix flag is specified. If the DST matrix flag (use_dstquantization_matrix_flag) is 1, parameters for the DST quantization matrix and compound transform quantization matrices are additionally specified. The syntax for the DST quantization matrix is stated in FIG. 11. Also, the syntax of parameters for the compound transform quantization matrices is stated in FIG. 13.

In FIG. 11, the FOR statements on line 15 and line 16 mean that processing is repeated for each matrix size and type. However, in the present embodiment, the DST quantization matrix is used only for 4×4 luma (Y) intra prediction. For this reason, the processing enclosed by these FOR statements is effectively executed only one time. However, the processing may be repeated a greater number of times in the case of using the DST quantization matrix for other sizes or other types.

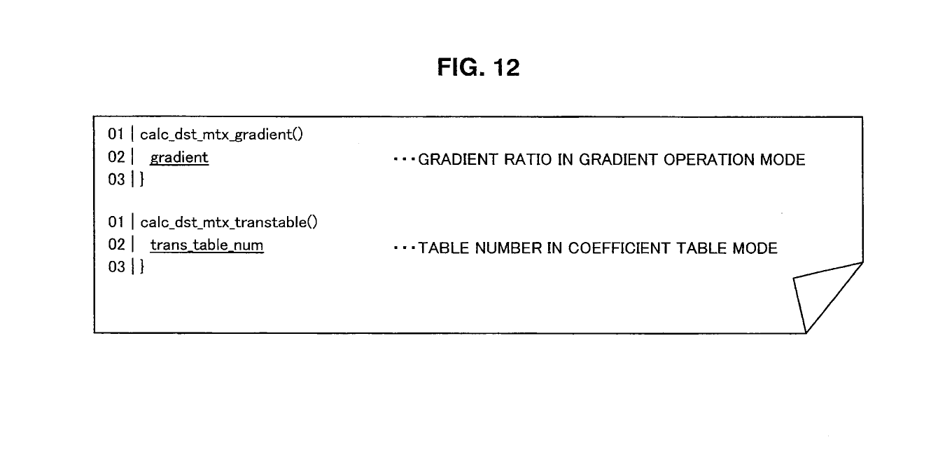

On line 17, the generation mode (predict_mode) for the DST quantization matrix is specified. The function qmatrix_dst(i,j) on line 19 specifies differential data in full scan mode. The function residual_matrix(i,j) on line 21 specifies residual data in residual mode. The function calc_dst_mtx_gradient( ) on line 23 specifies a gradient ratio (gradient) in gradient mode (see FIG. 12). The function calc_dst_mtx_transtable( ) on line 25 specifies a table number (trans_table_num) in coefficient table mode (see FIG. 12).

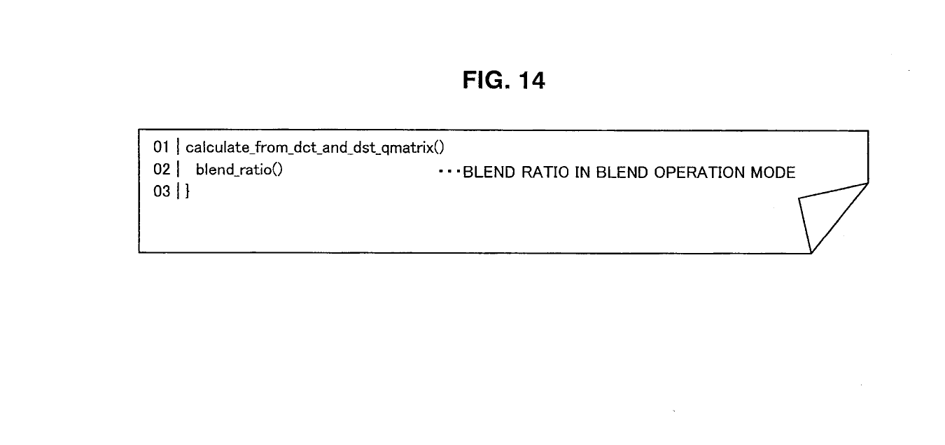

Referring to FIG. 13, on line 31, the blend operation flag (blend_flag) is specified. If the blend operation flag is 1, a blend ratio (blend ratio( ) is additionally specified by the function calculate_from_dct_and_dst_qmatrix( ) on line 33 (see FIG. 14). If the blend operation flag is not 1, the syntax on line 35 and thereafter is additionally specified.

The FOR statement on line 35 means that processing is repeated for the two compound transform methods, namely, the DST_DCT method and the DCT_DST method. On line 38, the generation mode (predict_mode) for the compound transform quantization matrices is specified. The function qmatrix_dctdst(h, i, j) on line 40 specifies differential data in full scan mode. The function residual_matrix(h, i, j) on line 42 specifies residual data in residual mode.

### 3. PROCESS FLOW DURING ENCODING ACCORDING TO EMBODIMENT

(1) Quantization Process

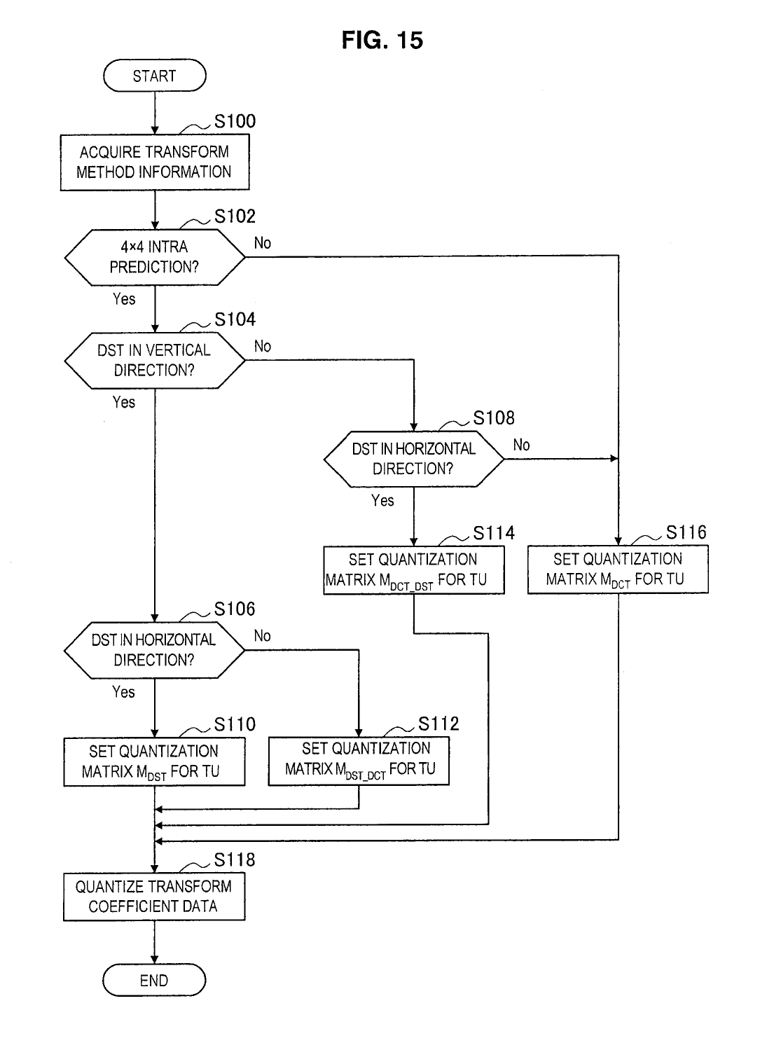

FIG. 15 is a flowchart illustrating an exemplary flow of a quantization process by the quantization section 16 according to the present embodiment. The quantization process illustrated in FIG. 15 may be repeatedly conducted on respective transform units in an image to be encoded.

Referring to FIG. 15, first, the quantization matrix setting section 162 acquires transform method information from the orthogonal transform section 15 (step S100). Next, the quantization matrix setting section 162 determines whether or not 4×4 intra prediction has been selected for the transform unit being processed (step S102). At this point, the process proceeds to step S116 in the case where 4×4 intra prediction has not been selected. In this case, the quantization matrix setting section 162 sets the DCT quantization matrix M_{DCT} for the transform unit (TU) being processed (step S116). On the other hand, the process proceeds to step S104 in the case where 4×4 intra prediction has been selected.

In step S104, the quantization matrix setting section 162 determines whether or not the DST is conducted in the vertical direction of the transform unit being processed (step S104). In addition, the quantization matrix setting section 162 determines whether or not the DST is conducted in the horizontal direction of the transform unit being processed (steps S106, S108).

Then, in the case where the DST is conducted in both the vertical direction and the horizontal direction, the quantization matrix setting section 162 sets the DST quantization matrix M_{DST} for the transform unit being processed (step S110). Also, in the case where the DST is conducted in the vertical direction and the DCT is conducted in the horizontal direction, the quantization matrix setting section 162 sets the DST_DCT quantization matrix M_{DST}_{_{—}}_{DCT} for the transform unit being processed (step S112). Also, in the case where the DCT is conducted in the vertical direction and the DST is conducted in the horizontal direction, the quantization matrix setting section 162 sets the DCT_DST quantization matrix M_{DCT}_{_{—}}_{DST} for the transform unit being processed (step S114). Also, in the case where the DCT is conducted in both the vertical direction and the horizontal direction, the quantization matrix setting section 162 sets the DCT quantization matrix M_{DCT} for the transform unit being processed (step S116).

The quantization computing section 164 then uses the quantization matrix set by the quantization matrix setting section 162 to quantize the transform coefficient data input from the orthogonal transform section 15 for the transform unit being processed (step S118).

(2) Modification

The present embodiment primarily describes an example in which each transform unit may be set with four types of quantization matrices that differ for every combination of orthogonal transform method used for orthogonal transform in the vertical direction and orthogonal transform method used for orthogonal transform in the horizontal direction. However, in order to reduce the complexity of the implementation of a device, it is also possible to use only the DCT quantization matrix and the DST quantization matrix, without using the compound transform quantization matrices.

In cases where compound transform quantization matrices are not used, the quantization matrix setting section 162 may determine a quantization matrix corresponding to the orthogonal transform method selected by the orthogonal transform section 15 according to the mapping indicated in the following Table 2.

TABLE 2
Setting a quantization matrix according to transform method in use
(modification)

| | | |
|---|---|---|
| Prediction | Transform method | Quantization |

| # | direction | Vertical | Horizontal | matrix |
|---|---|---|---|---|
| 0 | VER | DST | DCT | M_{DCT} |
| 1 | HOR | DCT | DST | M_{DCT} |
| 2 | DC | DCT | DCT | M_{DCT} |
| 3 | VER-8 | DST | DST | M_{DST} |
| 4 | VER-4 | DST | DST | M_{DST} |
| 5 | VER+4 | DST | DCT | M_{DCT} |
| 6 | VER+8 | DST | DCT | M_{DCT} |
| 7 | HOR-4 | DST | DST | M_{DST} |
| 8 | HOR+4 | DCT | DST | M_{DCT} |
| 9 | HOR+8 | DCT | DST | M_{DCT} |
| 10 | VER-6 | DST | DST | M_{DST} |
| 11 | VER-2 | DST | DST | M_{DST} |
| 12 | VER+2 | DST | DCT | M_{DCT} |
| 13 | VER+6 | DST | DCT | M_{DCT} |
| 14 | HOR-6 | DST | DST | M_{DST} |
| 15 | HOR-2 | DST | DST | M_{DST} |
| 16 | HOR+2 | DCT | DST | M_{DCT} |
| 17 | HOR+6 | DCT | DST | M_{DCT} |
| 18 | VER-7 | DST | DST | M_{DST} |
| 19 | VER-5 | DST | DST | M_{DST} |
| 20 | VER-3 | DST | DST | M_{DST} |
| 21 | VER-1 | DST | DST | M_{DST} |
| 22 | VER+1 | DST | DCT | M_{DCT} |
| 23 | VER+3 | DST | DCT | M_{DCT} |
| 24 | VER+5 | DST | DCT | M_{DCT} |
| 25 | VER+7 | DST | DCT | M_{DCT} |
| 26 | HOR-7 | DST | DST | M_{DST} |
| 27 | HOR-5 | DST | DST | M_{DST} |
| 28 | HOR-3 | DST | DST | M_{DST} |
| 29 | HOR-1 | DST | DST | M_{DST} |
| 30 | HOR+1 | DCT | DST | M_{DCT} |
| 31 | HOR+3 | DCT | DST | M_{DCT} |
| 32 | HOR+5 | DCT | DST | M_{DCT} |
| 33 | HOR+7 | DCT | DST | M_{DCT} |

According to Table 2, the DCT quantization matrix M_{DCT} is set for transform units in which the DCT is applied in at least one of the vertical direction and the horizontal direction, while the DST quantization matrix M_{DST} is set for transform units in which the DST is applied in both the vertical direction and the horizontal direction.

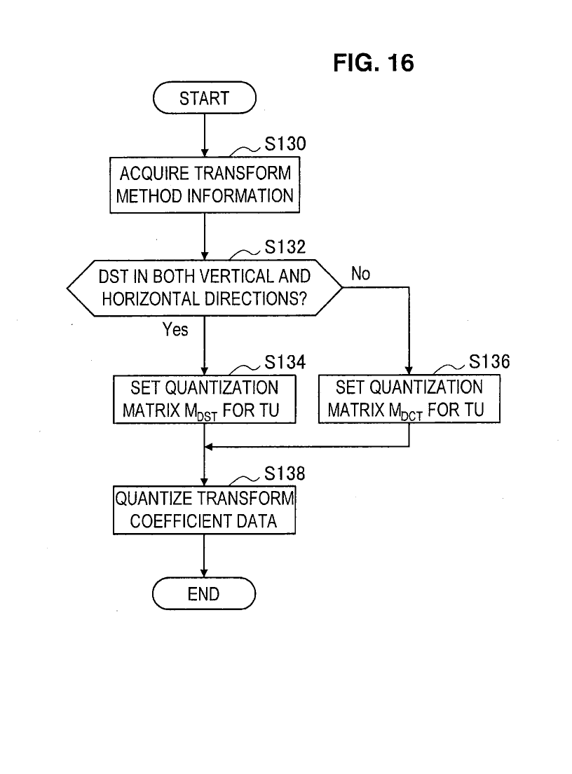

FIG. 16 is a flowchart illustrating an exemplary flow of a quantization process by the quantization section 16 according to the present modification. The quantization process illustrated in FIG. 16 may be repeatedly conducted on respective transform units in an image to be encoded.

Referring to FIG. 16, first, the quantization matrix setting section 162 acquires transform method information from the orthogonal transform section 15 (step S130). Next, the quantization matrix setting section 162 determines whether or not the DST is conducted in both the vertical direction and the horizontal direction of the transform unit being processed (step S132). At this point, in the case where the DST is conducted in both the vertical direction and the horizontal direction, the quantization matrix setting section 162 sets the DST quantization matrix M_{DST} for the transform unit being processed (step S134). Conversely, in the case where the DCT is conducted in at least one of the vertical direction and the horizontal direction, the quantization matrix setting section 162 sets the DCT quantization matrix M_{DCT} for the transform unit being processed (step S136).

The quantization computing section 164 then uses the quantization matrix set by the quantization matrix setting section 162 to quantize the transform coefficient data input from the orthogonal transform section 15 for the transform unit being processed (step S138).

According to the present modification, only fewer types of quantization matrices are used, thereby reducing the complexity of the implementation of a device. Consequently, it is possible to curb increases in costs associated with the implementation of a device, even in the case of adaptively switching the quantization matrix according to the orthogonal transform method. The parameters for generating the compound transform quantization matrices from among the quantization matrix parameters exemplified in FIG. 6 (such as the blend operation flag, for example) may also be omitted from the syntax.

### 4. EXEMPLARY CONFIGURATION OF IMAGE DECODING DEVICE ACCORDING TO EMBODIMENT

[4-1. Exemplary Overall Configuration]

This section describes an exemplary configuration of an image decoding device according to an embodiment.

[4-1. Exemplary Overall Configuration]

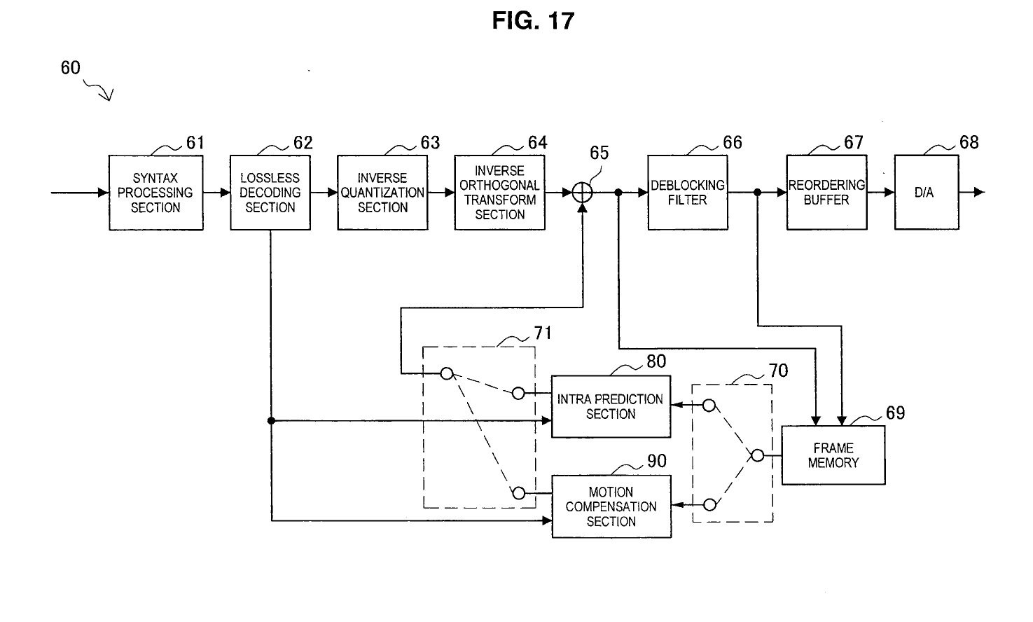

FIG. 17 is a block diagram illustrating an exemplary configuration of an image decoding device 60 according to an embodiment. Referring to FIG. 17, the image decoding device 60 is equipped with a syntax processing section 61, a lossless decoding section 62, an inverse quantization section 63, an inverse orthogonal transform section 64, an addition section 65, a deblocking filter 66, a reordering buffer 67, a digital-to-analog (D/A) conversion section 68, frame memory 69, selectors 70 and 71, an intra prediction section 80, and a motion compensation section 90.

The syntax processing section 61 acquires header information such as SPSs, PPSs, and slice headers from an encoded stream input via a transmission channel, and recognizes various settings for a decoding process by the image decoding device 60 on the basis of the acquired header information. For example, in the present embodiment, the syntax processing section 61 generates candidates for a quantization matrix to be possibly used during an inverse quantization process by the inverse quantization section 63 on the basis of quantization matrix parameters included in each parameter set. A detailed configuration of the syntax processing section 61 will be further described later.

The lossless decoding section 62 decodes the encoded stream input from the syntax processing section 63 according to the coding method used at the time of encoding. The lossless decoding section 62 then outputs the decoded quantization data to the inverse quantization section 62. In addition, the lossless decoding section 62 outputs information about intra prediction included in the header information to the intra prediction section 80, and outputs information about inter prediction to the motion compensation section 90.

The inverse quantization section 63 uses a quantization matrix adaptively switched from among the quantization matrix candidates generated by the syntax processing section 61 to inversely quantize the quantization data decoded by the lossless decoding section 62 (that is, quantized transform coefficient data). A detailed configuration of the inverse quantization section 63 will be further described later.

The inverse orthogonal transform section 64 uses the orthogonal transform method, selected from among multiple orthogonal transform method candidates, that was the orthogonal transform method used during encoding to inverse orthogonally transform the transform coefficient data inversely quantized by the inverse quantization section 63, and generates prediction error data. The inverse orthogonal transform section 64 then outputs the generated prediction error data to the addition section 65.

As discussed earlier, the orthogonal transform method candidates potentially selected by the inverse orthogonal transform section 64 may include methods such as a discrete cosine transform (DCT) method, a discrete sine transform (DST) method, a Hadamard transform method, a Karhunen-Loeve transform method, as well as combinations thereof. Herein, however, the DCT method and the DST method, as well as the compound transform methods which are combinations of these two methods, will be discussed primarily. A detailed configuration of the inverse orthogonal transform section 64 will be further described later.

The addition section 65 adds the prediction error data input from the inverse orthogonal transform section 64 to predicted image data input from the selector 71 to thereby generate decoded image data. Then, the addition section 65 outputs the decoded image data thus generated to the deblocking filter 66 and the frame memory 69.

The deblocking filter 66 removes blocking artifacts by filtering the decoded image data input from the addition section 65, and outputs the decoded image data thus filtered to the reordering buffer 67 and the frame memory 69.

The reordering buffer 67 generates a chronological sequence of image data by reordering images input from the deblocking filter 66. Then, the reordering buffer 67 outputs the generated image data to the D/A conversion section 68.

The D/A conversion section 68 converts the image data in a digital format input from the reordering buffer 67 into an image signal in an analog format. Then, the D/A conversion section 68 causes an image to be displayed by outputting the analog image signal to a display (not illustrated) connected to the image decoding device 60, for example.

The frame memory 69 uses a storage medium to store the unfiltered decoded image data input from the addition section 65 and the filtered decoded image data input from the deblocking filter 66.

The selector 70 switches the output destination of the image data from the frame memory 69 between the intra prediction section 80 and the motion compensation section 90 for each block in the image according to mode information acquired by the lossless decoding section 62. For example, in the case where an intra prediction mode is specified, the selector 70 outputs the unfiltered decoded image data that is supplied from the frame memory 69 to the intra prediction section 80 as reference image data. Also, in the case where an inter prediction mode is specified, the selector 70 outputs the filtered decoded image data that is supplied from the frame memory 69 to the motion compensation section 90 as reference image data.

The selector 71 switches the output source of predicted image data to be supplied to the addition section 65 between the intra prediction section 80 and the motion compensation section 90 for each block in the image according to the mode information acquired by the lossless decoding section 62. For example, in the case where an intra prediction mode is specified, the selector 71 supplies the addition section 65 with the predicted image data output from the intra prediction section 80. In the case where an inter prediction mode is specified, the selector 71 supplies the addition section 65 with the predicted image data output from the motion compensation section 90.

The intra prediction section 80 performs in-picture prediction of pixel values on the basis of the information about intra prediction input from the lossless decoding section 62 and the reference image data from the frame memory 69, and generates predicted image data. Then, the intra prediction section 80 outputs the predicted image data thus generated to the selector 71.

The motion compensation section 90 performs a motion compensation process on the basis of the information about inter prediction input from the lossless decoding section 62 and the reference image data from the frame memory 69, and generates predicted image data. Then, the motion compensation section 90 outputs the predicted image data thus generated to the selector 71.

[4-2. Exemplary Configuration of Syntax Processing Section]

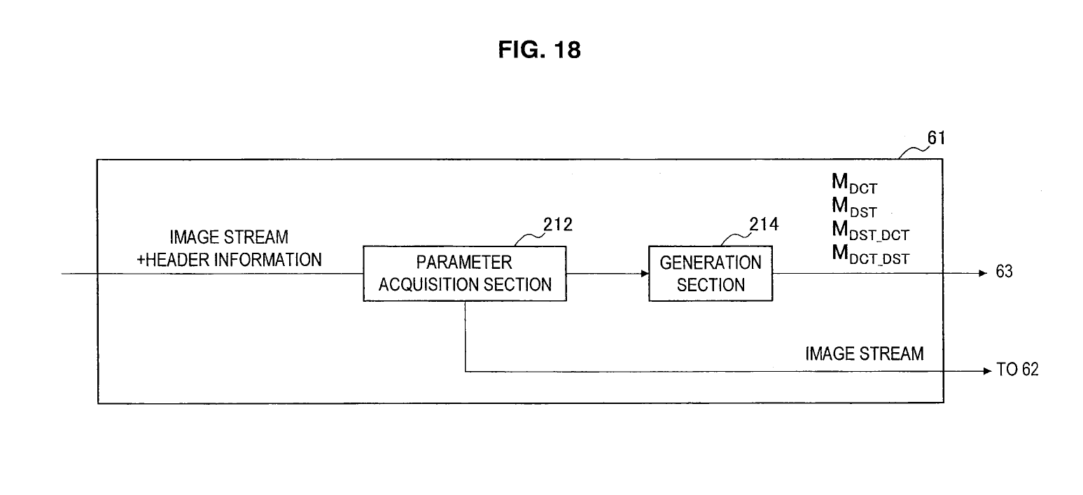

FIG. 18 is a block diagram illustrating an example of a detailed configuration of the syntax processing section 61 of the image decoding device 60 illustrated in FIG. 17. Referring to FIG. 18, the syntax processing section 61 includes a parameter acquisition section 212 and a generation section 214.

(1) Parameter Acquisition Section

The parameter acquisition section 212 recognizes header information such as SPSs, PPSs, and slice headers from the stream of image data, and acquires parameters included in the header information. For example, in the present embodiment, the parameter acquisition section 212 acquires quantization matrix parameters defining a quantization matrix from each parameter set. The parameter acquisition section 212 then outputs the acquired parameters to the generation section 214. The parameter acquisition section 212 also outputs the stream of image data to the lossless decoding section 62.

(2) Generation Section

The generation section 214 generates quantization matrices corresponding to each of the orthogonal transform method candidates which may be used by the inverse orthogonal transform section 64, on the basis of the quantization matrix parameters acquired by the parameter acquisition section 212. In the present embodiment, the quantization matrices generated by the generation section 214 include the DCT quantization matrix M_{DCT}, the DST quantization matrix M_{DST}, the DST_DCT quantization matrix M_{DST}_{_{—}}_{DCT}, and the DCT_DST quantization matrix M_{DCT}_{_{—}}_{DST}.

More specifically, in the case where the default quantization matrix is not used, for example, the generation section 214 generates the DCT quantization matrix M_{DCT} on the basis of a definition in the parameter set or the header of the encoded stream. In addition, the generation section 214 generates a DST quantization matrix in the case of using a DST quantization matrix. The DST quantization matrix may be generated according to any of the full scan mode, residual mode, gradient operation mode, and coefficient table mode discussed earlier. Typically, a DST quantization matrix may be generated such that the gradient of element values from low range to high range becomes smoother than the DCT quantization matrix. Additionally, the generation section 214 generates the compound transform quantization matrices M_{DST}_{_{—}}_{DCT} and M_{DCT}_{_{—}}_{DST}. The compound transform quantization matrices M_{DST}_{_{—}}_{DCT} and M_{DCT}_{_{—}}_{DST} may be generated according to any of the blend operation mode, full scan mode, and residual mode discussed earlier. The generation section 214 outputs quantization matrices generated in this way to the inverse quantization section 63.

[4-3. Exemplary Configuration of Inverse Quantization Section]

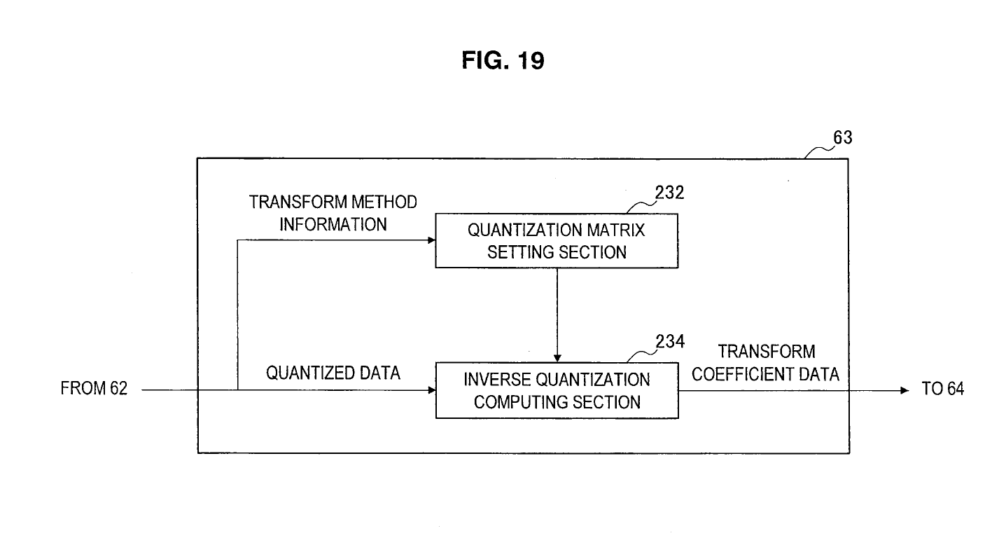

FIG. 19 is a block diagram illustrating an example of a detailed configuration of the inverse quantization section 63 of the image decoding device 60 illustrated in FIG. 17. Referring to FIG. 19, the inverse quantization section 63 includes a quantization matrix setting section 232 and an inverse quantization computing section 234.

(1) Quantization Matrix Setting Section

The quantization matrix setting section 232 sets a quantization matrix for inversely quantizing transform coefficient data in each transform unit according to the orthogonal transform method used by the inverse orthogonal transform section 64 from among multiple orthogonal transform methods. For example, the quantization matrix setting section 232 acquires transform method information included in the header information of an encoded stream. The transform method information may be identification information that identifies the orthogonal transform method selected for each transform unit, or information expressing the prediction technique, the size of the prediction units, and the prediction direction corresponding to each transform unit. Then, the quantization matrix setting section 232 recognizes the orthogonal transform method used for each transform unit from the transform method information, and sets, for each transform unit, a quantization matrix corresponding to the recognized orthogonal transform method from among the quantization matrices generated by the generation section 214 of the syntax processing section 61. The quantization matrix setting section 232 may also set a quantization matrix according to the mappings indicated in Table 1 or Table 2 discussed earlier.

Note that information directly specifying any of the quantization matrices M_{DCT}, M_{DST}, M_{DST}_{_{—}}_{DCT}, and M_{DCT}_{_{—}}_{DST} may also be included in the header information of an encoded stream. In this case, the quantization matrix setting section 232 sets the quantization matrix specified by that information for each transform unit.

(2) Inverse Quantization Computing Section

The inverse quantization computing section 234 uses the quantization matrix set by the quantization matrix setting section 232 to inversely quantize the transform coefficient data (quantized data) input from the orthogonal transform section 62 for each transform unit. The inverse quantization computing section 234 then outputs inversely quantized transform coefficient data to the inverse orthogonal transform section 64.

[4-4. Exemplary Configuration of Inverse Orthogonal Transform Section]

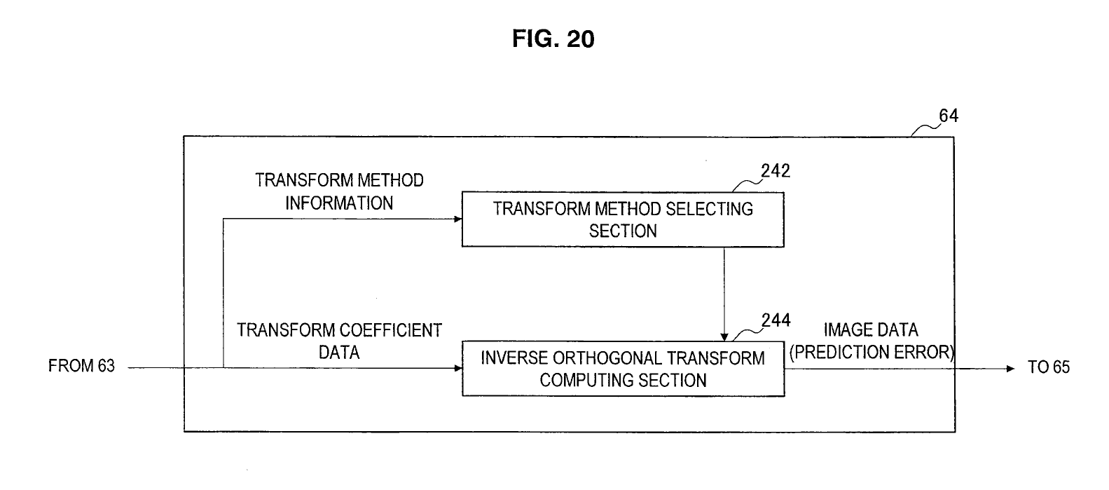

FIG. 20 is a block diagram illustrating an example of a detailed configuration of the inverse orthogonal transform section 64 of the image decoding device 60 illustrated in FIG. 17. Referring to FIG. 20, the inverse orthogonal transform section 64 includes a transform method selecting section 242 and an inverse orthogonal transform computing section 244.

(1) Transform Method Selecting Section

The transform method selecting section 242 selects, from among multiple orthogonal transform method candidates, an orthogonal transform method to use for the inverse orthogonal transform of transform coefficient data for each transform unit. In the present embodiment, the transform scheme selecting section 242 is able to select from among four types of orthogonal transform methods, called a) DCT method, b) DST method, c) DST_DCT method, and d) DCT_DST method. The transform method selecting section 242 may select an orthogonal transform method on the basis of the transform method information discussed earlier, according to a technique similar to the transform method selecting section 152 of the orthogonal transform section 15 in the image encoding device 10. Otherwise, the transform method selecting section 242 may select an orthogonal transform method which may be directly specified in the header information of an encoded stream.

(2) Orthogonal Transform Computing Section

The inverse orthogonal transform computing section 244 uses the orthogonal transform method selected by the transform method selecting section 242 to transform, for each transform unit, transform coefficient data input from the inverse quantization section 63 into prediction error data. The inverse orthogonal transform computing section 244 then outputs the transformed prediction error data to the addition section 65.

### 5. PROCESS FLOW DURING DECODING ACCORDING TO EMBODIMENT

(1) Quantization Matrix Generation Process

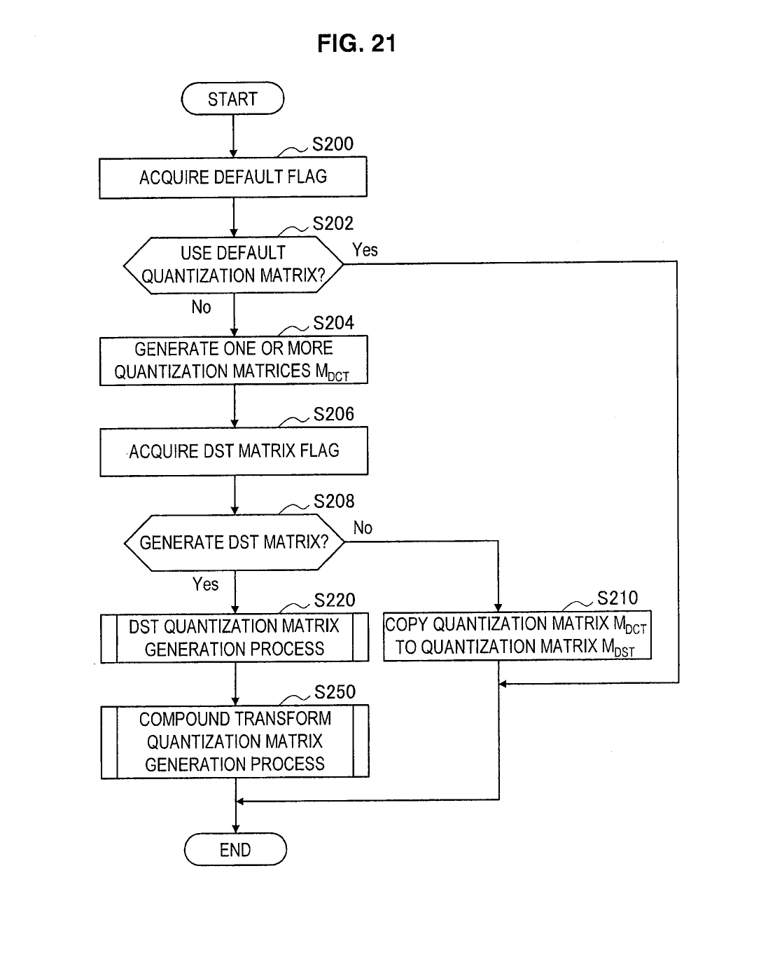

FIG. 21 is a flowchart illustrating an exemplary flow of a quantization matrix generation process by the generation section 214 of the syntax processing section 61 according to the present embodiment. The quantization matrix generation process illustrated in FIG. 21 may be conducted for each parameter set that includes quantization matrix parameters. Note that each parameter set is assumed to include quantization matrix parameters defined in accordance with syntax like that exemplified from FIG. 10 to FIG. 14.

Referring to FIG. 21, first, the generation section 214 acquires the default flag (step S200). The generation section 214 then determines whether or not a default quantization matrix is to be used, on the basis of the value of the default flag (step S202). At this point, the subsequent processing is skipped in the case where the default quantization matrix is to be used. On the other hand, the process proceeds to step S204 in the case where the default quantization matrix is not to be used.

In step S204, the generation section 214 uses parameters similar to an existing video coding scheme to generate one or more DCT quantization matrices M_{DCT} (step S204). The DCT quantization matrices M_{DCT} generated at this point may include a maximum of six types of quantization matrices (the Y/Cb/Cr components in intra prediction/inter prediction) corresponding to the respective 4×4, 8×8, 16×16, and 32×32 sizes of each transform unit.

Next, the generation section 214 acquires the DST matrix flag (step S206). The generation section 214 then determines whether or not to generate a DST quantization matrix, on the basis of the value of the DST matrix flag (step S208). At this point, in the case of determining to not generate a DST quantization matrix, the generation section 214 copies the DCT quantization matrix M_{DCT} to the DST quantization matrix M_{DST} for the luma (Y) of 4×4 intra prediction, for example. On the other hand, in the case of determining to generate a DST quantization matrix, the generation section 214 conducts a DST quantization matrix generation process (step S220) and a compound transform quantization matrix generation process (step S250).

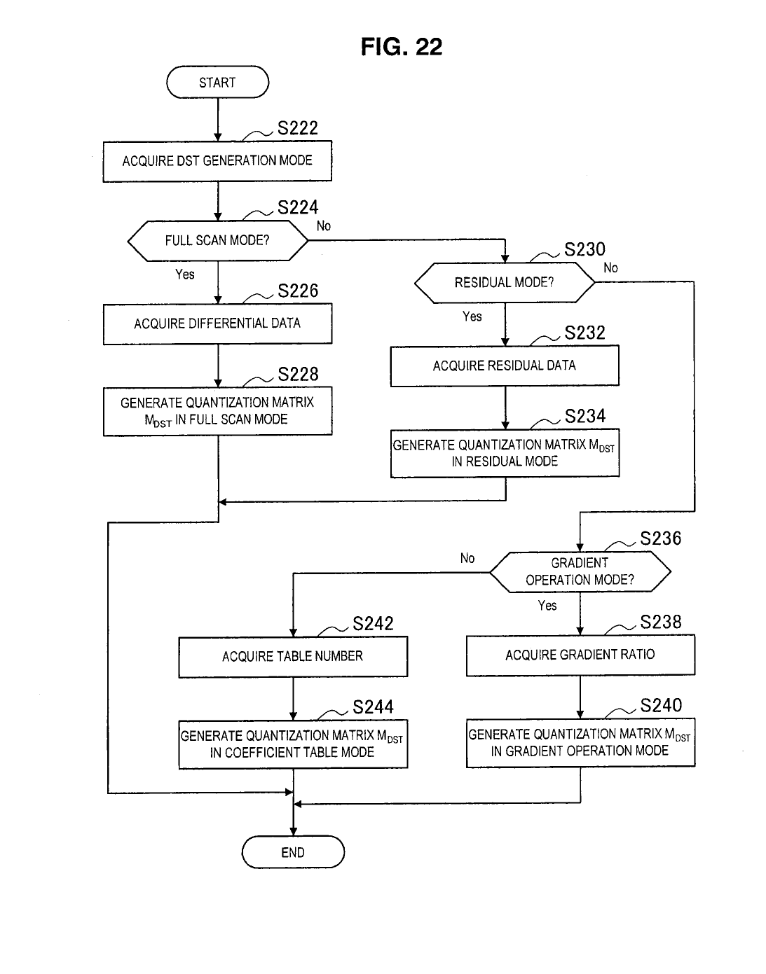

FIG. 22 illustrates an example of the flow of a DST quantization matrix generation process corresponding to step S220 of FIG. 21.

Referring to FIG. 22, first, the generation section 214 acquires the DST generation mode (step S222). The generation section 214 then switches the subsequent processing according to the value of the acquired generation mode.

For example, in the case where the generation mode indicates full scan mode (step S224), the generation section 214 acquires differential data (step S226), and generates the DST quantization matrix M_{DST} in full scan mode (step S228). In this case, the generation section 214 decodes differential data expressed as a linear array according to the DPCM format to obtain a linear array of element values. The generation section 214 then restructures the linear array of element values into a two-dimensional quantization matrix M_{DST} according to the scan pattern of a zigzag scan.

Additionally, in the case where the generation mode indicates residual mode (step S230), for example, the generation section 214 acquires residual data (step S232), and generates the DST quantization matrix M_{DST} in residual mode (step S234). In this case, the generation section 214 restructures the residual data expressed as a linear array into a two-dimensional residual matrix according to the scan pattern of a zigzag scan. The generation section 214 then generates the DST quantization matrix M_{DST} by adding together the restructured residual matrix and the DCT quantization matrix M_{DCT}.

Additionally, in the case where the generation mode indicates gradient operation mode (step S236), for example, the generation section 214 acquires a gradient ratio (step S238), and generates the DST quantization matrix M_{DST} in the gradient operation mode described using FIG. 7 (step S240). In this case, the generation section 214 generates the DST quantization matrix M_{DST} by using the acquired gradient ratio to vary the gradient of element values from low range to high range in the DCT quantization matrix M_{DCT}.

Additionally, in the case where the generation mode indicates coefficient table mode, for example, the generation section 214 acquires a table number (step S242), and generates the DST quantization matrix M_{DST} in the coefficient table mode described using FIG. 8 (step S244). In this case, the generation section 214 generates the DST quantization matrix M_{DST} by multiplying each element of the DCT quantization matrix M_{DCT} by the respective coefficients in the coefficient table identified by the table number.

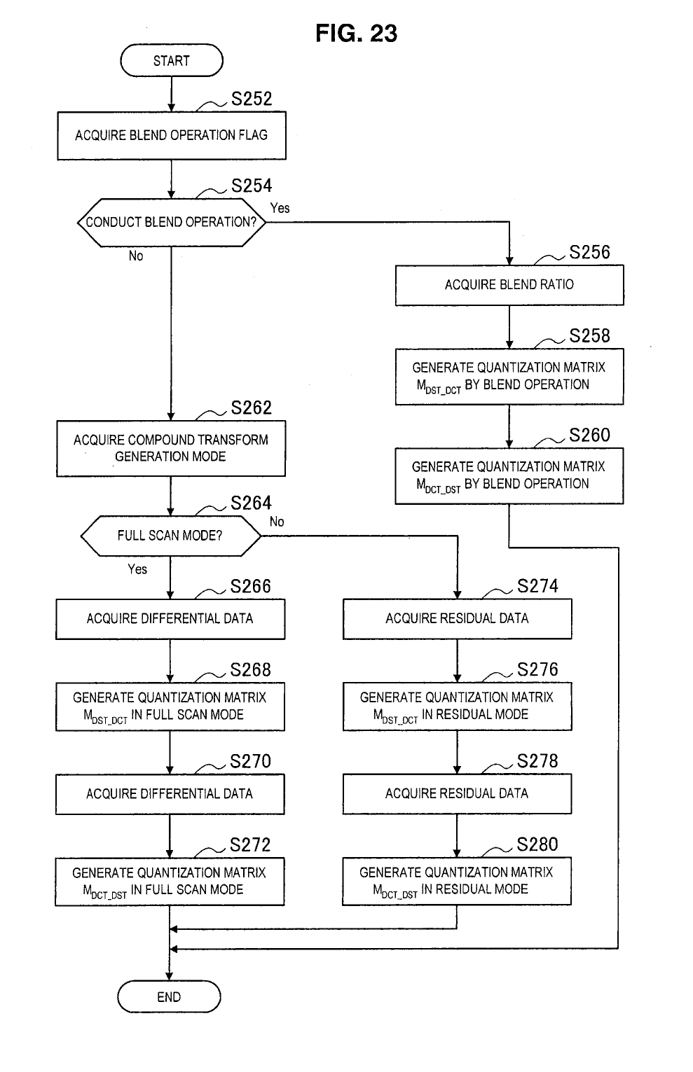

FIG. 23 illustrates an example of the flow of a compound transform quantization matrix generation process corresponding to step S250 of FIG. 21.

Referring to FIG. 23, first, the generation section 214 acquires the blend operation flag (step S252). The generation section 214 then determines whether or not to conduct a blend operation, on the basis of the value of the blend operation flag (step S254). At this point, the process proceeds to step S256 in the case of determining to conduct a blend operation. On the other hand, the process proceeds to step S262 in the case of determining to not conduct a blend operation.

In step S256, the generation section 214 acquires a blend ratio (step S256). The generation section 214 then generates the DST_DCT quantization matrix M_{DST}_{_{—}}_{DCT} in the blend operation mode described using FIG. 9 (step S258). In addition, the generation section 214 generates the DCT_DST quantization matrix M_{DCT}_{_{—}}_{DST} in blend operation mode (step S260).

In step S262, the generation section 214 acquires the compound transform generation mode (step S262). The generation section 214 then switches the subsequent processing according to the value of the acquired generation mode.

For example, in the case where the generation mode indicates full scan mode (step S264), the generation section 214 acquires DST_DCT differential data (step S266), and generates the DST_DCT quantization matrix M_{DST}_{_{—}}_{DCT} in full scan mode (step S268). In addition, the generation section 214 acquires DCT_DST differential data (step S270), and generates the DCT_DST quantization matrix M_{DCT}_{_{—}}_{DST} in full scan mode (step S272).

Additionally, in the case where the generation mode indicates residual mode, for example, the generation section 214 acquires DST_DCT residual data (step S274), and generates the DST_DCT quantization matrix M_{DST}_{_{—}}_{DCT} in residual mode (step S276). In addition, the generation section 214 acquires DCT_DST residual data (step S278), and generates the DCT_DST quantization matrix M_{DCT}_{_{—}}_{DST} in residual mode (step S280).

(2) Inverse Quantization Process

The flow of the inverse quantization process by the inverse quantization section 63 according to the present embodiment resembles the flow of the quantization process during encoding which is illustrated in FIG. 15. In other words, an orthogonal transform method is recognized by the quantization matrix setting section 232 for each transform unit, and a quantization matrix corresponding to the recognized orthogonal transform method is set for each transform unit. The quantization matrix set by the quantization matrix setting section 232 is then used by the inverse quantization computing section to inversely quantize transform coefficient data for each transform unit.

Also, in the inverse quantization section 63 only the DCT quantization matrix and the DST quantization matrix may be used, without using the compound transform quantization matrices. In this case, the setting of quantization matrices may be conducted according to the mapping indicated in Table 2 discussed earlier. An inverse quantization process by the inverse quantization section 63 may then be conducted according to a flow resembling the quantization process illustrated in FIG. 16.

### 6. EXAMPLE APPLICATION

The image encoding device 10 and the image decoding device 60 according to the embodiment described above may be applied to various electronic appliances such as a transmitter and a receiver for satellite broadcasting, cable broadcasting such as cable TV, distribution on the Internet, distribution to client devices via cellular communication, and the like, a recording device that records images onto a medium such as an optical disc, a magnetic disk, or flash memory, and a playback device that plays back images from such storage media. Four example applications will be described below.

[6-1. First Example Application]

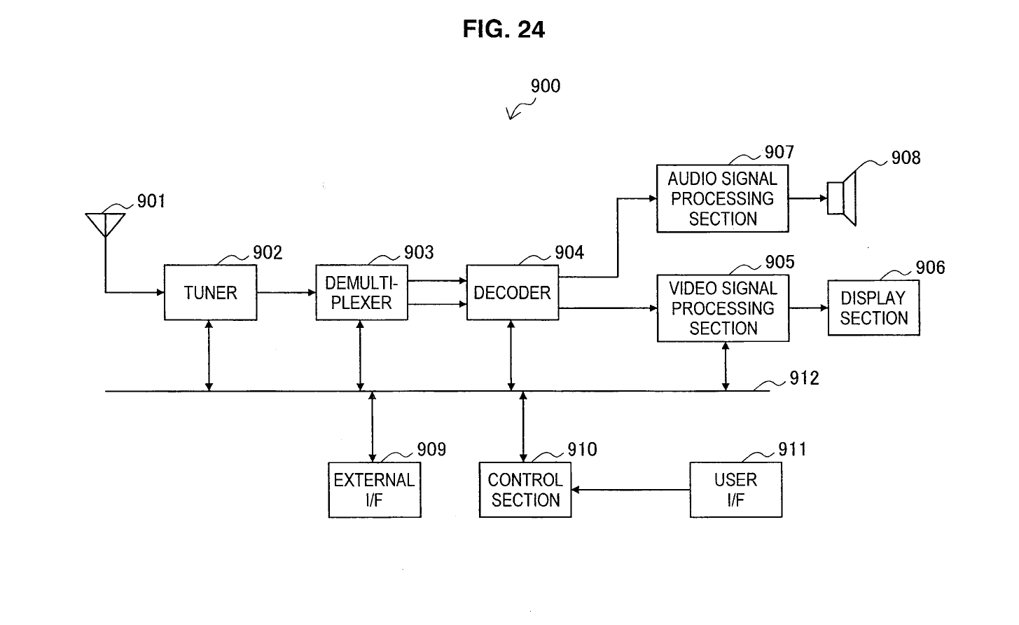

FIG. 24 is a block diagram illustrating an exemplary schematic configuration of a television adopting the embodiment described above. A television 900 includes an antenna 901, a tuner 902, a demultiplexer 903, a decoder 904, a video signal processing section 905, a display section 906, an audio signal processing section 907, a speaker 908, an external interface 909, a control section 910, a user interface 911, and a bus 912.

The tuner 902 extracts a signal of a desired channel from broadcast signals received via the antenna 901, and demodulates the extracted signal. Then, the tuner 902 outputs an encoded bit stream obtained by demodulation to the demultiplexer 903. That is, the tuner 902 serves as transmission means of the television 900 for receiving an encoded stream in which an image is encoded.

The demultiplexer 903 separates a video stream and an audio stream of a program to be viewed from the encoded bit stream, and outputs the separated streams to the decoder 904. Also, the demultiplexer 903 extracts auxiliary data such as an electronic program guide (EPG) from the encoded bit stream, and supplies the extracted data to the control section 910. Additionally, the demultiplexer 903 may perform descrambling in the case where the encoded bit stream is scrambled.

The decoder 904 decodes the video stream and the audio stream input from the demultiplexer 903. Then, the decoder 904 outputs video data generated by the decoding process to the video signal processing section 905. Also, the decoder 904 outputs the audio data generated by the decoding process to the audio signal processing section 907.

The video signal processing section 905 plays back the video data input from the decoder 904, and causes the display section 906 to display the video. The video signal processing section 905 may also cause the display section 906 to display an application screen supplied via a network. Further, the video signal processing section 905 may perform additional processes such as noise removal, for example, on the video data according to settings. Furthermore, the video signal processing section 905 may generate graphical user interface (GUI) images such as menus, buttons, or a cursor, for example, and superimpose the generated images onto an output image.

The display section 906 is driven by a drive signal supplied by the video signal processing section 905, and displays a video or an image on a video screen of a display device (such as a liquid crystal display, a plasma display, or an OLED display, for example).

The audio signal processing section 907 performs playback processes such as D/A conversion and amplification on the audio data input from the decoder 904, and outputs audio from the speaker 908. Also, the audio signal processing section 907 may perform additional processes such as noise removal on the audio data.

The external interface 909 is an interface for connecting the television 900 to an external appliance or a network. For example, a video stream or an audio stream received via the external interface 909 may be decoded by the decoder 904. That is, the external interface 909 also serves as transmission means of the televisions 900 for receiving an encoded stream in which an image is encoded.

The control section 910 includes a processor such as a central processing unit (CPU), and memory such as random access memory (RAM), and read-only memory (ROM). The memory stores a program to be executed by the CPU, program data, EPG data, data acquired via a network, and the like. The program stored in the memory is read and executed by the CPU when activating the television 900, for example. By executing the program, the CPU controls the operation of the television 900 according to an operation signal input from the user interface 911, for example.

The user interface 911 is connected to the control section 910. The user interface 911 includes buttons and switches used by a user to operate the television 900, and a remote control signal receiver, for example. The user interface 911 detects an operation by the user via these structural elements, generates an operation signal, and outputs the generated operation signal to the control section 910.

The bus 912 interconnects the tuner 902, the demultiplexer 903, the decoder 904, the video signal processing section 905, the audio signal processing section 907, the external interface 909, and the control section 910.

In a television 900 configured in this way, the decoder 904 includes the functions of an image decoding device 60 according to the foregoing embodiments. Consequently, it is possible to adaptively switch the quantization matrix on a basis of the orthogonal transform method to be used in each of the transform units for video decoded by the television 900.

[6-2. Second Example Application]

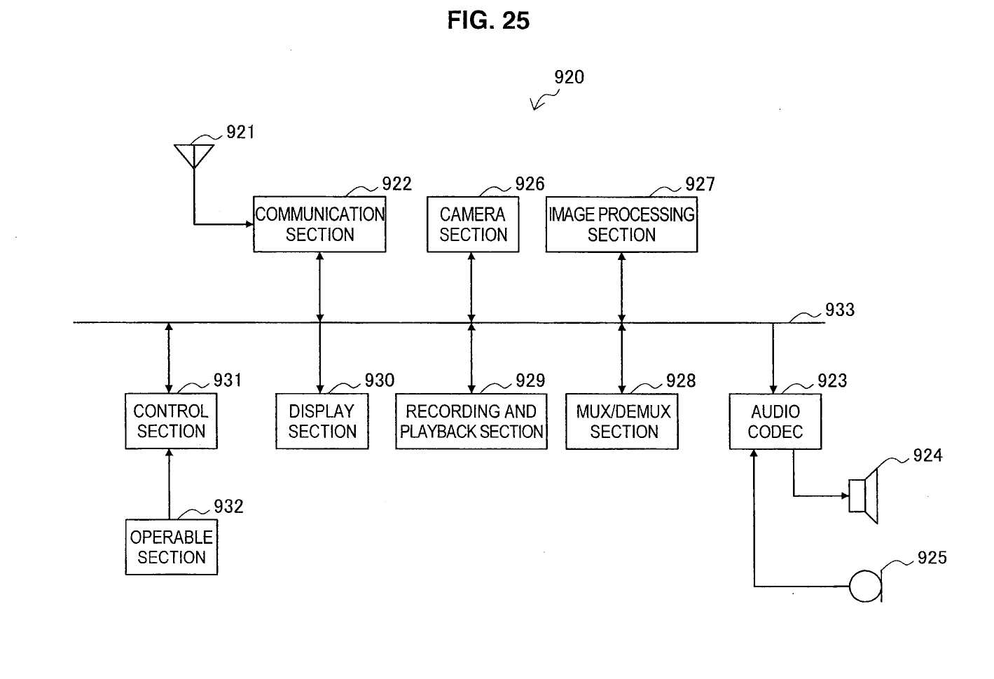

FIG. 25 is a block diagram illustrating an exemplary schematic configuration of a mobile phone adopting the embodiment described above. A mobile phone 920 includes an antenna 921, a communication section 922, an audio codec 923, a speaker 924, a microphone 925, a camera section 926, an image processing section 927, a multiplexing/demultiplexing (mux/demux) section 928, a recording and playback section 929, a display section 930, a control section 931, an operable section 932, and a bus 933.

The antenna 921 is connected to the communication section 922. The speaker 924 and the microphone 925 are connected to the audio codec 923. The operable section 932 is connected to the control section 931. The bus 933 interconnects the communication section 922, the audio codec 923, the camera section 926, the image processing section 927, the mux/demux section 928, the recording and playback section 929, the display 930, and the control section 931.

The mobile phone 920 performs operations such as transmitting and receiving audio signals, transmitting and receiving emails or image data, taking images, and recording data in various operating modes including an audio communication mode, a data communication mode, an imaging mode, and a videophone mode.

In the audio communication mode, an analog audio signal generated by the microphone 925 is supplied to the audio codec 923. The audio codec 923 converts the analog audio signal into audio data, and A/D converts and compresses the converted audio data. Then, the audio codec 923 outputs the compressed audio data to the communication section 922. The communication section 922 encodes and modulates the audio data, and generates a transmit signal. Then, the communication section 922 transmits the generated transmit signal to a base station (not illustrated) via the antenna 921. Also, the communication section 922 amplifies a wireless signal received via the antenna 921 and converts the frequency of the wireless signal, and acquires a received signal. Then, the communication section 922 demodulates and decodes the received signal and generates audio data, and outputs the generated audio data to the audio codec 923. The audio codec 923 decompresses and D/A converts the audio data, and generates an analog audio signal. Then, the audio codec 923 supplies the generated audio signal to the speaker 924 and causes audio to be output.

Also, in the data communication mode, the control section 931 generates text data that makes up an email, according to operations by a user via the operable section 932, for example. Moreover, the control section 931 causes the text to be displayed on the display section 930. Furthermore, the control section 931 generates email data according to transmit instructions from the user via the operable section 932, and outputs the generated email data to the communication section 922. The communication section 922 encodes and modulates the email data, and generates a transmit signal. Then, the communication section 922 transmits the generated transmit signal to a base station (not illustrated) via the antenna 921. Also, the communication section 922 amplifies a wireless signal received via the antenna 921 and converts the frequency of the wireless signal, and acquires a received signal. Then, the communication section 922 demodulates and decodes the received signal, reconstructs the email data, and outputs the reconstructed email data to the control section 931. The control section 931 causes the display section 930 to display the contents of the email, and also causes the email data to be stored in the storage medium of the recording and playback section 929.

The recording and playback section 929 includes an arbitrary readable and writable storage medium. For example, the storage medium may be a built-in storage medium such as RAM, or flash memory, or an externally mounted storage medium such as a hard disk, a magnetic disk, a magneto-optical disc, an optical disc, USB memory, or a memory card.

Furthermore, in the imaging mode, the camera section 926 takes an image of a subject, generates image data, and outputs the generated image data to the image processing section 927, for example. The image processing section 927 encodes the image data input from the camera section 926, and causes the encoded stream to be stored in the storage medium of the recording and playback section 929.

Furthermore, in the videophone mode, the mux/demux section 928 multiplexes a video stream encoded by the image processing section 927 and an audio stream input from the audio codec 923, and outputs the multiplexed stream to the communication section 922, for example. The communication section 922 encodes and modulates the stream, and generates a transmit signal. Then, the communication section 922 transmits the generated transmit signal to a base station (not illustrated) via the antenna 921. Also, the communication section 922 amplifies a wireless signal received via the antenna 921 and converts the frequency of the wireless signal, and acquires a received signal. The transmit signal and received signal may include an encoded bit stream. Then, the communication section 922 demodulates and decodes the received signal, reconstructs the stream, and outputs the reconstructed stream to the mux/demux section 928. The mux/demux section 928 separates a video stream and an audio stream from the input stream, and outputs the video stream to the image processing section 927 and the audio stream to the audio codec 923. The image processing section 927 decodes the video stream, and generates video data. The video data is supplied to the display section 930, and a series of images is displayed by the display section 930. The audio codec 923 decompresses and D/A converts the audio stream, and generates an analog audio signal. Then, the audio codec 923 supplies the generated audio signal to the speaker 924 and causes audio to be output.

In a mobile phone 920 configured in this way, the image processing section 927 includes the functions of the image encoding device 10 and the image decoding device 60 according to the foregoing embodiments. Consequently, it is possible to adaptively switch the quantization matrix on a basis of the orthogonal transform method to be used in each of the transform units for video encoded and decoded by the mobile phone 920.

[6-3. Third Example Application]

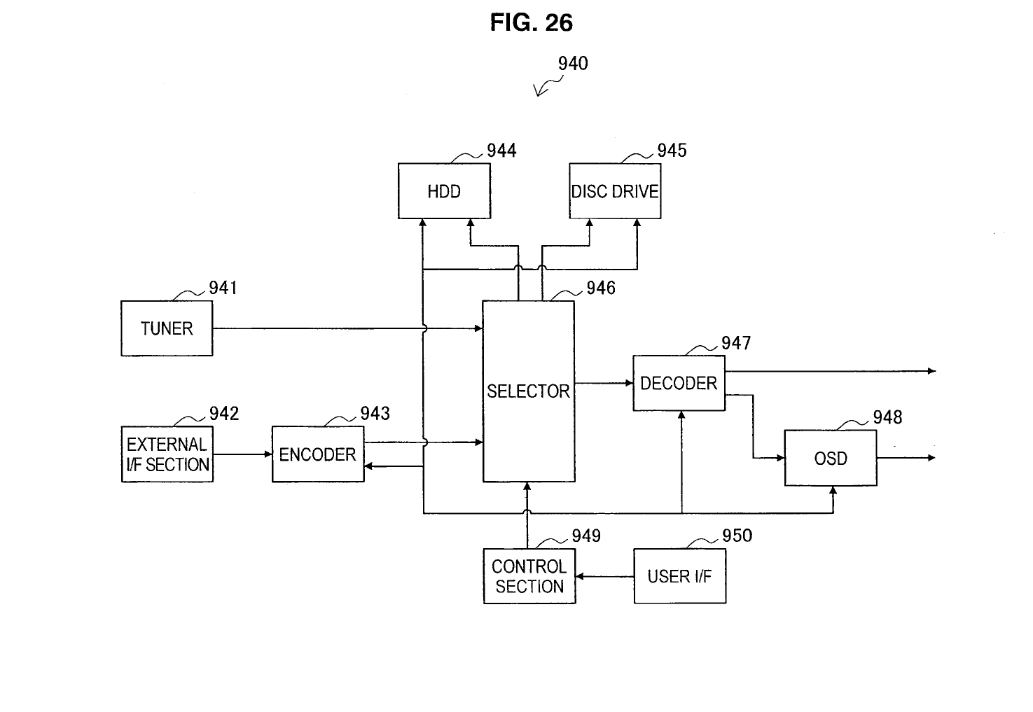

FIG. 26 is a block diagram illustrating an exemplary schematic configuration of a recording and playback device adopting the embodiment described above. A recording and playback device 940 encodes, and records onto a recording medium, the audio data and video data of a received broadcast program, for example. The recording and playback device 940 may also encode, and record onto the recording medium, audio data and video data acquired from another device, for example. Furthermore, the recording and playback device 940 plays back data recorded onto the recording medium via a monitor and speaker according to instructions from a user, for example. At such times, the recording and playback device 940 decodes the audio data and the video data.

The recording and playback device 940 includes a tuner 941, an external interface 942, an encoder 943, a hard disk drive (HDD) 944, a disc drive 945, a selector 946, a decoder 947, an on-screen display (OSD) 948, a control section 949, and a user interface 950.

The tuner 941 extracts a signal of a desired channel from broadcast signals received via an antenna (not illustrated), and demodulates the extracted signal. Then, the tuner 941 outputs an encoded bit stream obtained by demodulation to the selector 946. That is, the tuner 941 serves as transmission means of the recording and playback device 940.

The external interface 942 is an interface for connecting the recording and playback device 940 to an external appliance or a network. For example, the external interface 942 may be an IEEE 1394 interface, a network interface, a USB interface, a flash memory interface, or the like. For example, video data and audio data received by the external interface 942 are input into the encoder 943. That is, the external interface 942 serves as transmission means of the recording and playback device 940.

In the case where the video data and the audio data input from the external interface 942 are not encoded, the encoder 943 encodes the video data and the audio data. Then, the encoder 943 outputs the encoded bit stream to the selector 946.

The HDD 944 records onto an internal hard disk an encoded bit stream, which is compressed content data such as video or audio, various programs, and other data. Also, the HDD 944 reads such data from the hard disk when playing back video and audio.

The disc drive 945 records or reads data with respect to an inserted recording medium. The recording medium inserted into the disc drive 945 may be a DVD disc (such as a DVD-Video, DVD-RAM, DVD-R, DVD-RW, DVD+, or DVD+RW disc), a Blu-ray (registered trademark) disc, or the like, for example.

When recording video and audio, the selector 946 selects an encoded bit stream input from the tuner 941 or the encoder 943, and outputs the selected encoded bit stream to the HDD 944 or the disc drive 945. Also, when playing back video and audio, the selector 946 outputs an encoded bit stream input from the HDD 944 or the disc drive 945 to the decoder 947.

The decoder 947 decodes the encoded bit stream, and generates video data and audio data. Then, the decoder 947 outputs the generated video data to the OSD 948. Also, the decoder 904 outputs the generated audio data to an external speaker.

The OSD 948 plays back the video data input from the decoder 947, and displays video. Also, the OSD 948 may superimpose GUI images, such as menus, buttons, or a cursor, for example, onto displayed video.

The control section 949 includes a processor such as a CPU, and memory such as RAM or ROM. The memory stores a program to be executed by the CPU, program data, and the like. A program stored in the memory is read and executed by the CPU when activating the recording and playback device 940, for example. By executing the program, the CPU controls the operation of the recording and playback device 940 according to an operation signal input from the user interface 950, for example.

The user interface 950 is connected to the control section 949. The user interface 950 includes buttons and switches used by a user to operate the recording and playback device 940, and a remote control signal receiver, for example. The user interface 950 detects an operation by the user via these structural elements, generates an operation signal, and outputs the generated operation signal to the control section 949.

In a recording and playback device 940 configured in this way, the encoder 943 includes the functions of the image encoding device 10 according to the foregoing embodiments. In addition, the decoder 947 includes the functions of the image decoding device 60 according to the foregoing embodiments. Consequently, it is possible to adaptively switch the quantization matrix on a basis of the orthogonal transform method to be used in each of the transform units for video encoded and decoded by the recording and playback device 940.

[6-4. Fourth Example Application]

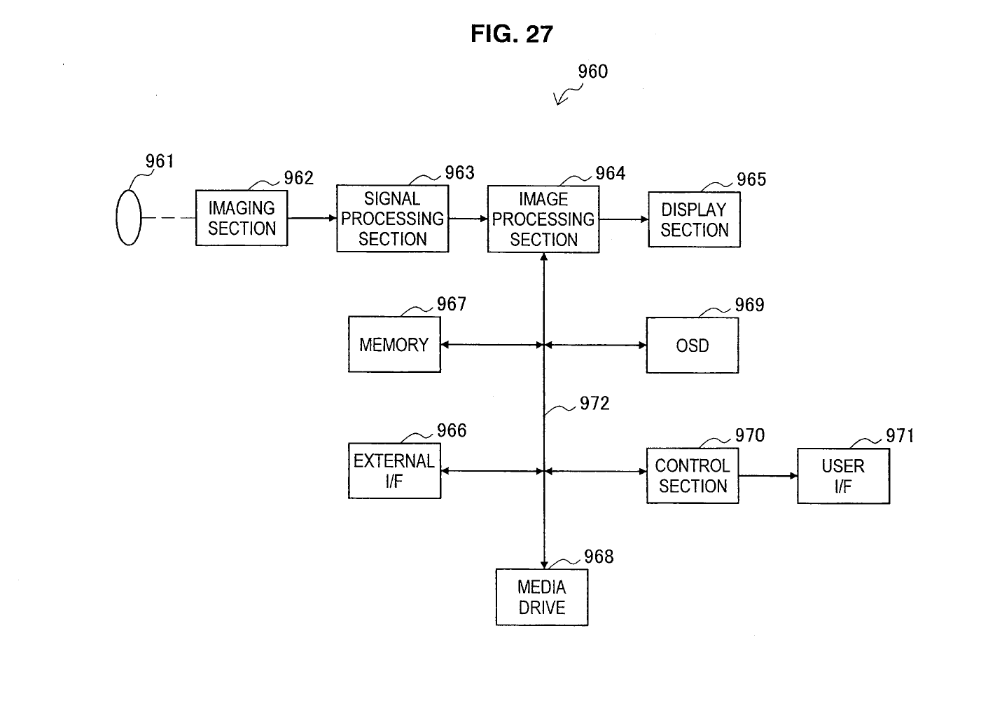

FIG. 27 is a block diagram showing an example of a schematic configuration of an imaging device adopting the embodiment described above. An imaging device 960 takes an image of a subject, generates an image, encodes the image data, and records the image data onto a recording medium.

The imaging device 960 includes an optical block 961, an imaging section 962, a signal processing section 963, an image processing section 964, a display section 965, an external interface 966, memory 967, a media drive 968, an OSD 969, a control section 970, a user interface 971, and a bus 972.

The optical block 961 is connected to the imaging section 962. The imaging section 962 is connected to the signal processing section 963. The display section 965 is connected to the image processing section 964. The user interface 971 is connected to the control section 970. The bus 972 interconnects the image processing section 964, the external interface 966, the memory 967, the media drive 968, the OSD 969, and the control section 970.

The optical block 961 includes a focus lens, an aperture stop mechanism, and the like. The optical block 961 forms an optical image of a subject on the imaging surface of the imaging section 962. The imaging section 962 includes an image sensor such as a CCD or CMOS sensor, and photoelectrically converts the optical image formed on the imaging surface into an image signal which is an electrical signal. Then, the imaging section 962 outputs the image signal to the signal processing section 963.

The signal processing section 963 performs various camera signal processes such as knee correction, gamma correction, and color correction on the image signal input from the imaging section 962. The signal processing section 963 outputs the processed image data to the image processing section 964.

The image processing section 964 encodes the image data input from the signal processing section 963, and generates encoded data. Then, the image processing section 964 outputs the encoded data thus generated to the external interface 966 or the media drive 968. Also, the image processing section 964 decodes encoded data input from the external interface 966 or the media drive 968, and generates image data. Then, the image processing section 964 outputs the generated image data to the display section 965. Also, the image processing section 964 may output the image data input from the signal processing section 963 to the display section 965, and cause the image to be displayed. Furthermore, the image processing section 964 may superimpose display data acquired from the OSD 969 onto an image to be output to the display section 965.

The OSD 969 generates GUI images such as menus, buttons, or a cursor, for example, and outputs the generated images to the image processing section 964.

The external interface 966 is configured as an USB input/output terminal, for example. The external interface 966 connects the imaging device 960 to a printer when printing an image, for example. Also, a drive is connected to the external interface 966 as necessary. A removable medium such as a magnetic disk or an optical disc, for example, is inserted into the drive, and a program read from the removable medium may be installed in the imaging device 960. Furthermore, the external interface 966 may be configured as a network interface to be connected to a network such as a LAN or the Internet. That is, the external interface 966 serves as transmission means of the image capturing device 960.

A recording medium to be inserted into the media drive 968 may be an arbitrary readable and writable removable medium, such as a magnetic disk, a magneto-optical disc, an optical disc, or semiconductor memory, for example. Also, a recording medium may be permanently installed in the media drive 968 to constitute a non-portable storage section such as an internal hard disk drive or a solid-state drive (SSD), for example.

The control section 970 includes a processor such as a CPU, and memory such as RAM or ROM. The memory stores a program to be executed by the CPU, program data, and the like. A program stored in the memory is read and executed by the CPU when activating the imaging device 960, for example. By executing the program, the CPU controls the operation of the imaging device 960 according to an operation signal input from the user interface 971, for example.

The user interface 971 is connected to the control section 970. The user interface 971 includes buttons, switches and the like used by a user to operate the imaging device 960, for example. The user interface 971 detects an operation by the user via these structural elements, generates an operation signal, and outputs the generated operation signal to the control section 970.

In an imaging device 960 configured in this way, the image processing section 964 includes the functions of the image encoding device 10 and the image decoding device 60 according to the foregoing embodiments. Consequently, it is possible to adaptively switch the quantization matrix on a basis of the orthogonal transform method to be used in each of the transform units for video encoded and decoded by the imaging device 960.

### 7. CONCLUSION

The foregoing uses FIGS. 1 to 27 to describe an image encoding device 10 and an image decoding device 60 according to an embodiment. According to the present embodiment, when quantizing and inversely quantizing transform coefficient data, different quantization matrices are set for each transform unit according to an orthogonal transform method selected for the purpose of orthogonal transform or inverse orthogonal transform from among multiple orthogonal transform method candidates. Transform coefficient data is then quantized or inversely quantized using the quantization matrix set for each transform unit. According to such a configuration, it is possible to adaptively switch quantization matrices according to the orthogonal transform method in use. In other words, since quantization or inverse quantization is conducted using a quantization matrix that is better suited to the properties of the orthogonal transform method or the tendency of the transform coefficient data, it is possible to mitigate worsened image quality due to quantization compared to the case of using a static quantization matrix.

Also, according to the present embodiment, the above multiple orthogonal transform method candidates include a discrete cosine transform (DCT) method and a discrete sine transform (DST) method. These two orthogonal transform methods differ in how readily transform coefficients are exhibited, particularly in high-frequency components, as discussed earlier. Consequently, by implementing the quantization matrix switching mechanism discussed above, it is possible to compress the bit rate of transform coefficient data while appropriately leaving significant differences in the transform coefficients even after quantization.

Also, according to the present embodiment, a quantization matrix corresponding to the DST method may be generated from a quantization matrix corresponding to the DCT method. Consequently, since a high bit rate for the purpose of transmitting the DST quantization matrix is not required, it is possible to introduce the quantization matrix switching mechanism discussed above without greatly lowering the coding efficiency. Note that the foregoing example is not limiting, and that a quantization matrix corresponding to the DCT method (or some other orthogonal transform method) may also be generated from a quantization matrix corresponding to the DST method (or some other orthogonal transform method), for example.

Also, according to the present embodiment, in the case where orthogonal transform methods may be respective selected for each of the vertical direction and the horizontal direction, quantization matrices that differ for every combination of orthogonal transform methods in the vertical direction and the horizontal direction may be set for each transform unit. Consequently, since quantization matrices suited to the various tendencies of transform coefficient data are appropriately set for each transform unit, it is possible to effectively suppress the degradation of image quality.

Also, according to the present embodiment, quantization matrices corresponding to compound transform methods (methods in which respectively different types of orthogonal transforms are conducted in two directions) may be generated from quantization matrices corresponding to non-compound transform methods (methods in which the same type of orthogonal transform is conducted in two directions). Consequently, a higher bit rate and lowered coding efficiency are likewise avoided for the transmission of compound transform quantization matrices.

Note that this specification describes an example in which the quantization matrix parameter multiplexed into the header of the encoded stream and transmitted from the encoding side to the decoding side. However, the technique of transmitting the quantization matrix parameter is not limited to such an example. For example, header information may also be transmitted or recorded as separate data associated with an encoded bit stream without being multiplexed into the encoded bit stream. Herein, the term “associated” means that images included in the bit stream (also encompassing partial images such as slices or blocks) and information corresponding to those images can be linked at the time of decoding. In other words, information may also be transmitted on a separate transmission channel from an image (or bit stream). Also, the information may be recorded to a separate recording medium (or a separate recording area on the same recording medium) from the image (or bit stream). Furthermore, information and images (or bit streams) may be associated with each other in arbitrary units such as multiple frames, single frames, or portions within frames, for example.

The foregoing thus describes preferred embodiments of the present disclosure in detail and with reference to the attached drawings. However, the technical scope of the present disclosure is not limited to such examples. It is clear to persons ordinarily skilled in the technical field to which the present disclosure belongs that various modifications or alterations may occur insofar as they are within the scope of the technical ideas stated in the claims, and it is to be understood that such modifications or alterations obviously belong to the technical scope of the present disclosure.

Additionally, the present technology may also be configured as below.

(1)

An image processing device including:
a setting section that sets, for respective transform units, a quantization matrix used when inversely quantizing transform coefficient data of an image to be decoded, according to an orthogonal transform method selected when inversely orthogonally transforming the transform coefficient data;
an inverse quantization section that uses the quantization matrix set by the setting section to inversely quantize the transform coefficient data; and
a transform section that uses the selected orthogonal transform method to inversely orthogonally transform the transform coefficient data inversely quantized by the inverse quantization section.
   (2)

The image processing device according to (1), further including:
a generation section that generates the quantization matrix based on a definition in one of a parameter set and header of an encoded stream.
   (3)

The image processing device according to (2), wherein
candidates of orthogonal transform methods to be selected include a first orthogonal transform method and a second orthogonal transform method that differs from the first orthogonal transform method,
a quantization matrix corresponding to the first orthogonal transform method is defined in one of a parameter set and header of an encoded stream, and
the generation section generates a quantization matrix corresponding to the second orthogonal transform method from a quantization matrix corresponding to the first orthogonal transform method.
   (4)

The image processing device according to (3),
wherein the first orthogonal transform method is a discrete cosine transform (DCT) method, and
wherein the second orthogonal transform method is a discrete sine transform (DST) method.
   (5)

The image processing device according to (4), wherein
the generation section generates a quantization matrix corresponding to the DST method from a quantization matrix corresponding to the DCT method, so as to make a smoother gradient of element values from low range to high range in a quantization matrix corresponding to the DCT.
   (6)

The image processing device according to (5), wherein
the generation section generates a quantization matrix corresponding to the DST method by varying the gradient of a quantization matrix corresponding to the DCT method according to a given rate.
   (7)

The image processing device according to (5), wherein
the generation section generates a quantization matrix corresponding to the DST method by multiplying each element in a quantization matrix corresponding to the DCT method by a coefficient corresponding to element position.

(8)

The image processing device according to any one of (3) to (7), wherein
the generation section generates a quantization matrix corresponding to the second orthogonal transform method from a quantization matrix corresponding to the first orthogonal transform method in a case where one of a parameter set and header of an encoded stream includes a flag indicating that a quantization matrix corresponding to the second orthogonal transform method is to be generated from a quantization matrix corresponding to the first orthogonal transform method.
   (9)

The image processing device according to any one of (3) to (8), wherein
the generation section generates a quantization matrix corresponding to the second orthogonal transform method in a case where one of a parameter set and header of an encoded stream includes a flag indicating that a quantization matrix corresponding to the second orthogonal transform method is to be used.
   (10)

The image processing device according to (1), wherein
the transform section is able to select different orthogonal transform methods for orthogonal transform in a vertical direction and orthogonal transform in a horizontal direction, and
the setting section sets, for respective transform units, quantization matrices that differ for every combination of orthogonal transform method used for orthogonal transform in the vertical direction and orthogonal transform method used for orthogonal transform in the horizontal direction.
   (11)

The image processing device according to (10), further including:
a generation section that generates compound transform quantization matrices, corresponding to a case in which two orthogonal transform methods respectively used for orthogonal transform in the vertical direction and the horizontal direction differ from each other, from one or more non-compound transform quantization matrices corresponding to a case in which the two orthogonal transform methods are equal.
   (12)

The image processing device according to (11),
wherein the compound transform quantization matrices are quantization matrices corresponding combination of a discrete cosine transform (DCT) method and a discrete sine transform (DST) method, and
wherein the one or more non-compound transform quantization matrices include a quantization matrix corresponding to the DCT method and a quantization matrix corresponding to the DST method.
   (13)

The image processing device according to (12), wherein
the generation section generates the compound transform quantization matrices by taking a weighted average of a quantization matrix corresponding to the DCT method and a quantization matrix corresponding to the DST method.
   (14)

The image processing device according to (13), wherein
the generation section acquires a parameter for specifying weighting of the weighted average from one of a parameter set and header of an encoded stream.
   (15)

An image processing method including:
setting, for respective transform units, a quantization matrix used when inversely quantizing transform coefficient data of an image to be decoded, according to an orthogonal transform method selected when inversely orthogonally transforming the transform coefficient data;
inversely quantizing the transform coefficient data using the set quantization matrix; and
inversely orthogonally transforming the inversely quantized transform coefficient data using the selected orthogonal transform method.
   (16)

An image processing device including:
a transform section that transforms image data into transform coefficient data using an orthogonal transform method selected for respective transform units of an image to be encoded;
a setting section that sets a quantization matrix used when quantizing the transform coefficient data for respective transform units according to an orthogonal transform method used by the transform section; and
a quantization section that uses the quantization matrix set by the setting section to quantize the transform coefficient data.
   (17)

An image processing method including:
transforming image data into transform coefficient data using an orthogonal transform method selected for respective transform units of an image to be encoded;
setting a quantization matrix used when quantizing the transform coefficient data for respective transform units according to an orthogonal transform method used when transforming the image data; and
quantizing the transform coefficient data using the set quantization matrix.

### REFERENCE SIGNS LIST

10 Image processing device (image encoding device)
15 Orthogonal transform section
16 Quantization section
162 Quantization matrix setting section
60 Image processing device (image decoding device)
63 Inverse quantization section
64 Inverse orthogonal transform section
214 Generation section
232 Quantization matrix setting section

1. An image processing device comprising:
a setting section that sets, for respective transform units, a quantization matrix used when inversely quantizing transform coefficient data of an image to be decoded, according to an orthogonal transform method selected when inversely orthogonally transforming the transform coefficient data;
an inverse quantization section that uses the quantization matrix set by the setting section to inversely quantize the transform coefficient data; and
a transform section that uses the selected orthogonal transform method to inversely orthogonally transform the transform coefficient data inversely quantized by the inverse quantization section.

2. The image processing device according to claim 1, further comprising:
a generation section that generates the quantization matrix based on a definition in one of a parameter set and header of an encoded stream.

3. The image processing device according to claim 2, wherein
candidates of orthogonal transform methods to be selected include a first orthogonal transform method and a second orthogonal transform method that differs from the first orthogonal transform method,
a quantization matrix corresponding to the first orthogonal transform method is defined in one of a parameter set and header of an encoded stream, and
the generation section generates a quantization matrix corresponding to the second orthogonal transform method from a quantization matrix corresponding to the first orthogonal transform method.

4. The image processing device according to claim 3,
wherein the first orthogonal transform method is a discrete cosine transform (DCT) method, and
wherein the second orthogonal transform method is a discrete sine transform (DST) method.

5. The image processing device according to claim 4, wherein
the generation section generates a quantization matrix corresponding to the DST method from a quantization matrix corresponding to the DCT method, so as to make a smoother gradient of element values from low range to high range in a quantization matrix corresponding to the DCT.

6. The image processing device according to claim 5, wherein
the generation section generates a quantization matrix corresponding to the DST method by varying the gradient of a quantization matrix corresponding to the DCT method according to a given rate.

7. The image processing device according to claim 5, wherein
the generation section generates a quantization matrix corresponding to the DST method by multiplying each element in a quantization matrix corresponding to the DCT method by a coefficient corresponding to element position.

8. The image processing device according to claim 3, wherein
the generation section generates a quantization matrix corresponding to the second orthogonal transform method from a quantization matrix corresponding to the first orthogonal transform method in a case where one of a parameter set and header of an encoded stream includes a flag indicating that a quantization matrix corresponding to the second orthogonal transform method is to be generated from a quantization matrix corresponding to the first orthogonal transform method.

9. The image processing device according to claim 3, wherein
the generation section generates a quantization matrix corresponding to the second orthogonal transform method in a case where one of a parameter set and header of an encoded stream includes a flag indicating that a quantization matrix corresponding to the second orthogonal transform method is to be used.

10. The image processing device according to claim 1, wherein
the transform section is able to select different orthogonal transform methods for orthogonal transform in a vertical direction and orthogonal transform in a horizontal direction, and
the setting section sets, for respective transform units, quantization matrices that differ for every combination of orthogonal transform method used for orthogonal transform in the vertical direction and orthogonal transform method used for orthogonal transform in the horizontal direction.

11. The image processing device according to claim 10, further comprising:
a generation section that generates compound transform quantization matrices, corresponding to a case in which two orthogonal transform methods respectively used for orthogonal transform in the vertical direction and the horizontal direction differ from each other, from one or more non-compound transform quantization matrices corresponding to a case in which the two orthogonal transform methods are equal.

12. The image processing device according to claim 11,
wherein the compound transform quantization matrices are quantization matrices corresponding combination of a discrete cosine transform (DCT) method and a discrete sine transform (DST) method, and
wherein the one or more non-compound transform quantization matrices include a quantization matrix corresponding to the DCT method and a quantization matrix corresponding to the DST method.

13. The image processing device according to claim 12, wherein
the generation section generates the compound transform quantization matrices by taking a weighted average of a quantization matrix corresponding to the DCT method and a quantization matrix corresponding to the DST method.

14. The image processing device according to claim 13, wherein
the generation section acquires a parameter for specifying weighting of the weighted average from one of a parameter set and header of an encoded stream.

15. An image processing method comprising:
setting, for respective transform units, a quantization matrix used when inversely quantizing transform coefficient data of an image to be decoded, according to an orthogonal transform method selected when inversely orthogonally transforming the transform coefficient data;
inversely quantizing the transform coefficient data using the set quantization matrix; and
inversely orthogonally transforming the inversely quantized transform coefficient data using the selected orthogonal transform method.

16. An image processing device comprising:
a transform section that transforms image data into transform coefficient data using an orthogonal transform method selected for respective transform units of an image to be encoded;
a setting section that sets a quantization matrix used when quantizing the transform coefficient data for respective transform units according to an orthogonal transform method used by the transform section; and
a quantization section that uses the quantization matrix set by the setting section to quantize the transform coefficient data.

17. An image processing method comprising:
transforming image data into transform coefficient data using an orthogonal transform method selected for respective transform units of an image to be encoded;
setting a quantization matrix used when quantizing the transform coefficient data for respective transform units according to an orthogonal transform method used when transforming the image data; and
quantizing the transform coefficient data using the set quantization matrix.
